(19) United States
(12) Patent Application Publication
(10) Pub. No.: US 2020/0226563 A1
(43) Pub. Date: Jul. 16, 2020

(54) METHOD AND SYSTEM FOR PROCESSING CASH-DEPOSIT TRANSACTIONS

(71) Applicant: Mastercard International Incorporated, Purchase, NY (US)

(72) Inventors: Shrinivas Ambadas Kalvit, Pune (IN); Ritesh Chaudhari, Pune (IN); Sudhir Shirke, Pune (IN)

(21) Appl. No.: 16/733,817

(22) Filed: Jan. 3, 2020

(30) Foreign Application Priority Data
Jan. 14, 2019 (SG) 10201900312X

(51) Int. Cl. G06Q 20/10; G06Q 20/40; G07D 11/60; G07D 11/00

(52) U.S. Cl. CPC G06Q 20/1085; G07D 11/009; G07D 11/60; G06Q 20/407

(57) ABSTRACT

A method for facilitating cash-deposit transactions includes generation of a transaction code by a currency recycler, when a customer submits one or more currency bills to the currency recycler for a cash-deposit transaction. The customer captures the transaction code using a service application accessible on a customer device. The customer provides account details of a recipient account to the service application. An issuer receives the transaction code and the account details from the service application, and communicates an approval request to the currency recycler, seeking an approval of the customer for the cash-deposit transaction. The currency recycler communicates an approval response to the issuer when the customer approves the cash-deposit transaction. The issuer credits an amount equivalent to the value of the one or more currency bills to the recipient account based on the approval response.

### FIELD OF THE INVENTION

The present invention relates to the field of electronic transactions, and, more particularly to a method and a system for processing cash-deposit transactions performed at terminal devices.

### BACKGROUND

Technological advancements have allowed financial institutions to offer a variety of services, such as cash deposits, cash withdrawals, payments of utility bills, or the like. Some of these financial institutions operate currency recyclers (also known as bunch note acceptors, BNAs) that allow customers to perform various transactions, such as cash-withdrawal transactions, cash-deposit transactions, or the like. Prior to the advent of currency recyclers, the customers had to engage in cumbersome activities, such as visiting issuer premises and interacting with employees at the issuer premises whenever the customers wanted to deposit money in their accounts. Thus, the process of depositing cash in the accounts has been simplified by the currency recyclers.

Typically, a customer is required to use a transaction card at a currency recycler for performing a cash-deposit transaction. In one exemplary scenario, the customer may not carry the transaction card. In such a case, the customer is unable to perform the cash-deposit transaction at the currency recycler, thereby causing inconvenience to the customer.

In light of the foregoing, there exists a need for a technical solution that eliminates the requirement of carrying transaction cards for performing cash-deposit transactions at currency recyclers. Further, there exists a need for a technical solution that supports interoperability, i.e., a customer of one bank is allowed to deposit cash by using any other bank's recycler.

### SUMMARY

In an embodiment of the present invention, a method for facilitating cash-deposit transactions is provided. The method includes hosting, by a first issuer server of a first issuer, a service application that is accessible to a first customer on a customer device. A transaction code and account details of a recipient account are received by the issuer server from the service application. The transaction code is generated by a currency recycler when the first customer submits one or more currency bills to the currency recycler for performing a cash-deposit transaction. The transaction code is captured by the service application. An approval request is communicated to the currency recycler by the first issuer server for the cash-deposit transaction, when the transaction code is valid. Based on the approval request, the currency recycler presents an option to the first customer to approve the cash-deposit transaction. An approval response is received by the issuer server from the currency recycler for the cash-deposit transaction, when the first customer selects the option to approve the cash-deposit transaction. The first issuer server initiates a credit of an amount equivalent to a value of the one or more currency bills to the recipient account based on the approval response.

In another embodiment of the present invention, a system for facilitating cash-deposit transactions is provided. The system includes an issuer server that is configured to host a service application accessible to a first customer on a customer device. The issuer server receives a transaction code and account details of a recipient account from the service application. The transaction code is generated by a currency recycler when the first customer submits one or more currency bills to the currency recycler for performing a cash-deposit transaction. The transaction code is captured by the service application. The issuer server communicates, to the currency recycler, an approval request for the cash-deposit transaction, when the transaction code is valid. The currency recycler presents an option to the first customer to approve the cash-deposit transaction based on the approval request. The issuer server receives an approval response from the currency recycler for the cash-deposit transaction, when the first customer selects the option to approve the cash-deposit transaction. The issuer server initiates a credit of an amount equivalent to a value of the one or more currency bills to the recipient account based on the approval response.

In yet another embodiment of the present invention, a method for facilitating cash-deposit transactions is provided. The method includes rendering, by a currency recycler, a user interface to present a first option to a customer for performing a cash-deposit transaction at the currency recycler. The customer selects the first option to perform the cash-deposit transaction. A transaction code is generated by the currency recycler. The transaction code is indicative of a first identifier assigned to the currency recycler and a first amount equivalent to a value of one or more currency bills submitted by the customer to the currency recycler for the cash-deposit transaction. A service application accessible to a customer on a customer device captures the transaction code. The service application communicates the transaction code and account details of a recipient account to a first issuer hosting the service application. An approval request is received by the currency recycler from the first issuer, when the transaction code is determined to be valid by the first issuer. The currency recycler displays a second option on the user interface based on the approval request, seeking an approval from the customer for the cash-deposit transaction. The currency recycler transmits, to the first issuer, an approval response for the cash-deposit transaction based on a selection of the second option by the customer. The approval response causes the first issuer to initiate a credit of the first amount to the recipient account.

### BRIEF DESCRIPTION OF THE DRAWINGS

Various embodiments of the present invention are illustrated by way of example, and not limited by the appended figures, in which like references indicate similar elements, and in which:

FIG. 1 is a block diagram that illustrates an exemplary environment in which various embodiments of the present invention are practiced;

FIGS. 2A-2C, collectively represent a process flow diagram that illustrates an exemplary scenario for facilitating cash-deposit transactions, in accordance with an embodiment of the present invention;

FIGS. 3A-3D, collectively represent another process flow diagram that illustrates another exemplary scenario for facilitating cash-deposit transactions, in accordance with another embodiment of the present invention;

FIGS. 4A and 4B represent user interface (UI) screens rendered by a currency recycler of FIG. 1, in accordance with an embodiment of the present invention;

FIGS. 5A and 5B represent UI screens that are rendered on a display of a customer device of FIG. 1, in accordance with an embodiment of the present invention;

FIG. 6 is a block diagram that illustrates a first issuer server of FIG. 1, in accordance with an embodiment of the present invention;

FIG. 7 is a block diagram that illustrates the currency recycler of FIG. 1, in accordance with an embodiment of the present invention;

FIGS. 8A-8C, collectively represent a flow chart that illustrates a method facilitating cash-deposit transactions, in accordance with an embodiment of the present invention;

FIGS. 9A and 9B, collectively represent a flow chart that illustrates the method for facilitating cash-deposit transactions, in accordance with another embodiment of the present invention;

FIG. 10 represents a high-level flow chart that illustrates the method for facilitating cash-deposit transactions, in accordance with an embodiment of the present invention;

FIG. 11 represents a high-level flow chart that illustrates the method for facilitating cash-deposit transactions, in accordance with another embodiment of the present invention; and

FIG. 12 is block diagram that illustrates system architecture of a computer system, in accordance with another embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the present invention.

### DETAILED DESCRIPTION

The present invention is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

### OVERVIEW

A customer may interact with a currency recycler to perform a cash-deposit transaction for depositing money in a customer account. For performing the cash-deposit transaction at the currency recycler, the customer is required to use her transaction card. However, in a scenario where the customer is not carrying the transaction card, the customer is unable to perform the cash-deposit transaction at the currency recycler, thereby causing inconvenience to the customer.

Various embodiments of the present invention provide a method and a system that solve the abovementioned problems by enabling the customer to perform cash-deposit transactions at a currency recycler without requiring a transaction card. The currency recycler renders a user interface (UI) that presents a first option for performing cash-deposit transactions. The customer that wishes to perform a cash-deposit transaction approaches the currency recycler and selects the first option. The customer then submits currency bills or coins to the currency recycler for depositing. The currency recycler generates a transaction code based on a value of the currency bills submitted by the customer and a location identifier (such as an address) of the currency recycler, and displays the transaction code on its display. The customer then accesses a service application, hosted by a first issuer, on her customer device to capture the transaction code. When the transaction code is captured by the service application, the service application prompts the customer to enter account details of an account (such as a bank account, a digital wallet, or any other digital account) that is to be credited with a first amount equivalent to the value of the submitted currency bills. In one scenario, the customer may be the account holder of the account. In another scenario, the account may belong to a third-party beneficiary. The service application then communicates the transaction code and the account details to the first issuer. The first issuer initiates validation of the transaction code and the account details, and generates an approval request for the cash-deposit transaction. The approval request includes the account details of the account that is to be credited. The first issuer communicates the approval request to the currency recycler for receiving a confirmation from the customer. Based on the approval request, the currency recycler displays the account details and presents a second option to the customer for approving the cash-deposit transaction. The first issuer receives, from the currency recycler, an approval response for the cash-deposit transaction when the customer selects the second option. Based on the approval response, the first issuer initiates a credit of the first amount to the account.

Thus, the method and system of the present invention support interoperability and enable the customer to perform cash-deposit transactions at the currency recycler without a requiring transaction card. Further, the method and system of the present invention enable the customer to fund digital wallets by depositing cash at the currency recycler. TERMS DESCRIPTION (in addition to plain and dictionary meaning)

Cash-deposit transaction is a transaction performed by a customer to deposit money in a digital account. The customer performs the cash-deposit transaction by submitting one or more currency bills and/ or coins to a currency recycler. The digital account may be one of a bank account of the customer, a digital wallet of the customer, a bank account of a third-party beneficiary, a digital wallet of the third-party beneficiary, or the like.

Service application is an application accessible to a customer on a customer device. The service application allows the customer to perform cash-deposit transactions at currency recyclers. The service application may be a mobile application installed on the customer device or a web application accessible through a browser installed on the customer device. The service application may be offered by an issuer or a payment network.

Currency recycler (also known as cash recycler or bunch note acceptor, i.e., BNA) is a terminal device operated by an acquirer for facilitating transactions, such as cash-withdrawal transactions, cash-deposit transactions, or the like. The currency recycler includes circuitry and mechanisms that allow the currency recycler to identify and count one or more currency bills submitted by the customer to the currency recycler.

Transaction code is a code generated by a currency recycler when a customer performs a cash-deposit transaction at the currency recycler. The transaction code may be a numeric code, an alphanumeric code, a pictorial code (e.g., a bar code or a quick response code, i.e., a QR code), or the like. The transaction code may include information such as a transaction amount of the cash-deposit transaction and an identifier of the currency recycler.

Issuer is a financial institution which establishes and maintains customer accounts of several customers. The issuer authorizes and settles transactions in accordance with various payment network regulations and local legislation.

Payment networks, such as those operated by Mastercard®, process transactions between acquirers and issuers. Processing by a payment network includes steps of authorization, clearing, and settlement.

Server is a physical or cloud data processing system on which a server program runs. The server may be implemented in hardware or software, or a combination thereof. In one embodiment, the server may be implemented in computer programs executing on programmable computers, such as personal computers, laptops, or a network of computer systems. The server may correspond to one of an acquirer server, a payment network server, or an issuer server.

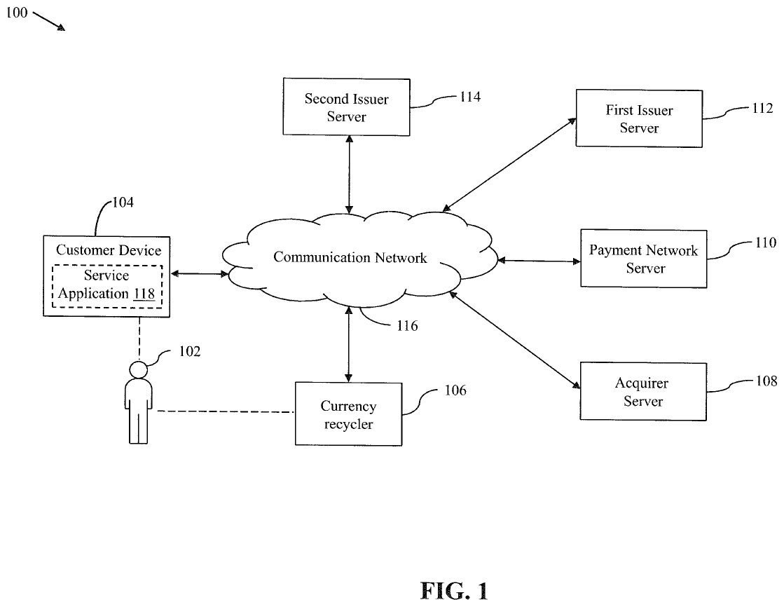

FIG. 1 is a block diagram that illustrates an exemplary environment 100 in which various embodiments of the present invention are practiced. The environment 100 includes a first customer 102 in possession of a customer device 104. The environment 100 further includes a currency recycler 106, an acquirer server 108, a payment network server 110, a first issuer server 112, and a second issuer server 114. The customer device 104, the currency recycler 106, the acquirer server 108, the payment network server 110, the first issuer server 112, and the second issuer server 114 may communicate with each other by way of a communication network 116 or through separate communication networks established therebetween.

The first customer 102 is an individual, who is an account holder of a first customer account. The first customer account may be a first bank account maintained at a financial institution, such as a first issuer, or a first digital wallet maintained at the first issuer. Examples of the first digital wallet include, but are not limited to, Apple Pay Cash®, or the like. The first customer 102 is a cardholder of a first transaction card (not shown) issued by the first issuer. The first customer 102 may interact with the currency recycler 106 for performing cash-deposit transactions.

The customer device 104 is a communication device of the first customer 102. Examples of the customer device 104 include a smartphone, a personal computer, a tablet, a phablet, or the like. The customer device 104 is used by the first customer 102 to access a service application 118. The service application 118 may be a mobile application installed on the customer device 104 or a web application accessible by a browser installed on the customer device 104. The service application 118 facilitates cash-deposit transactions at currency recyclers (such as the currency recycler 106) and various other types of financial transactions such as purchases, funds transfers, or the like.

The currency recycler 106 is a terminal device that facilitates transactions, such as cash-deposit transactions, cash-withdrawal transactions, or the like. The currency recycler 106 is operated by an acquirer, such as a first acquirer associated with the acquirer server 108. The currency recycler 106 is assigned virtual identifiers (virtual IDs) by various payment networks supported by the currency recycler 106. For the sake of simplicity and without limiting the scope of the invention, it is assumed that the currency recycler 106 is assigned first through third virtual IDs by first through third payment networks, respectively. The first payment network is associated with the payment network server 110. The currency recycler 106 dynamically generates a transaction code when the first customer 102 submits currency bills or coins to the currency recycler 106 to perform a cash-deposit transaction. Examples of the transaction code include, a numeric code, an alphanumeric code, a pictorial code (e.g., a bar code or a QR code), or the like. For the sake of simplicity, it is assumed that the transaction code is a QR code. The QR code generated by the currency recycler 106 has encoded therein, various identifiers of the currency recycler 106 (i.e., the first through third virtual IDs) and a value of the currency bills deposited by the first customer 102. The QR code may also have encoded therein, information pertaining to currency of the currency bills, a location identifier (such as a country code, an address, a city name, or the like) of the currency recycler 106, a checksum, a merchant classification code (MCC) of the currency recycler 106, or the like.

The acquirer server 108 is a computing server operated by the first acquirer. The acquirer server 108 processes cash-deposit transactions initiated at various currency recyclers, such as the currency recycler 106, associated with the first acquirer. The acquirer server 108 communicates transaction messages of various transactions (such as the cash-deposit transaction) to corresponding issuers by way of the payment network server 110.

The payment network server 110 is a computing server that is operated by the first payment network. The first payment network is an intermediate entity between acquirers (for example, the first acquirer) and issuers for processing transactions. The payment network server 110 receives the transaction messages from the acquirer server 108 and routes them to the corresponding issuer server (for example, the first or second issuer server 112 or 114). The payment network server 110 may also receive transaction messages from the first and second issuer servers 112 and 114 and transmit the transaction messages to the corresponding acquirer server (such as the acquirer server 108). The first payment network assigns the first virtual ID to the currency recycler 106.

The first issuer server 112 is a computing server that is operated by the first issuer. The first issuer may be a financial institution that manages customer accounts (such as the first bank account and/or the first digital wallet) of multiple customers (such as the first customer 102) and issues transaction cards (such as the first transaction card) to the customers. Account details of the customer accounts established with the first issuer are stored as account profiles. The first issuer server 112 credits and debits the customer accounts based on cash-deposit and cash-withdrawal transactions performed by the customers (such as the first customer 102) from their accounts, respectively.

The second issuer server 114 is a computing server that is operated by a second issuer that is different from the first issuer. It will be apparent to those of skill in the art that the second issuer server 114 is functionally similar to the first issuer server 112.

The communication network 116 is a medium through which content and messages are transmitted between the customer device 104, the currency recycler 106, the acquirer server 108, the payment network server 110, the first issuer server 112, the second issuer server 114, and other entities that are pursuant to one or more standards for the interchange of transaction messages, such as the ISO8583 standard. Examples of the communication network 116 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 116 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, or any combination thereof.

The service application 118 is executable on various customer devices (such as the customer device 104) and enables the customers (such as the first customer 102) to perform the cash-deposit transactions at the currency recycler 106. The service application 118 may be hosted by the first issuer server 112 or any other financial institution. In a non-limiting example, it is assumed that the service application 118 is hosted by the first issuer server 112. The service application 118 allows the first customer 102, performing a cash-deposit transaction at the currency recycler 106, to capture the QR code generated by the currency recycler 106 and enter account details of a customer account (for example, a bank account or a digital wallet) that is to be credited based on the cash-deposit transaction. Hereinafter, the customer account that is to be credited based on the cash-deposit transaction is referred to as “recipient account”. The first customer 102 may have saved a virtual copy of the first transaction card on the service application 118. In one embodiment, the service application 118 allows the first customer 102 to access the first customer account on the customer device 104. In a scenario where the first customer account is the first bank account, the first customer 102 may link the first bank account to the service application 118. In another scenario where the first customer account is the first digital wallet, the first customer 102 may link the first digital wallet to the service application 118.

In operation, the first customer 102 interacts with the currency recycler 106 and submits one or more currency bills to the currency recycler 106 for performing a cash-deposit transaction. The currency recycler 106 generates and displays a QR code. The QR code is a function of the first through third virtual IDs, a value of the currency bills, a currency (for example, United States Dollar, i.e., USD) associated with the currency bills, the location identifier of the currency recycler 106, and the MCC of the currency recycler 106. The first customer 102 accesses the service application 118 on the customer device 104 to capture the QR code. The service application 118 may capture the QR code by various means, such as near field communication (NFC), Bluetooth, image scanning, or the like.

The first customer 102 submits the account details of the recipient account, which is to be credited based on the cash-deposit transaction, to the service application 118. In one embodiment, the recipient account is the first customer account (e.g., the first bank account or the first digital wallet) of the first customer 102. In another embodiment, the recipient account is a second customer account (e.g., a second bank account or a second digital wallet) of a third-party beneficiary. In one embodiment, the recipient account may be maintained at the first issuer server 112 hosting the service application 118. In another embodiment, the recipient account may be maintained at another issuer server (i.e., the second issuer server 114) that may not be hosting the service application 118. The account details of the recipient account may include a name of an account holder of the recipient account, an account identifier of the recipient account, or the like.

As the service application 118 is hosted by the first issuer server 112, the first issuer server 112 receives the captured QR code and the account details of the recipient account from the service application 118. The first issuer server 112 validates the QR code and the account details of the recipient account, and identifies a payment network (i.e., the first payment network) that corresponds to the first transaction card issued to the first customer 102. In one embodiment, when the recipient account is maintained at another issuer instead of the first issuer, the first issuer server 112 communicates with the other issuer to validate the account details of the recipient account. The first issuer server 112 communicates an approval request (e.g., a funds transfer request) to the acquirer server 108 by way of the payment network server 110 of the identified payment network server. The approval request includes the account details of the recipient account and a virtual ID (i.e., the first virtual ID) that corresponds to the identified payment network. Based on the approval request, the acquirer server 108 instructs the currency recycler 106 to display the account details of the recipient account and prompt the first customer 102 to approve the cash-deposit transaction. The currency recycler 106 displays the account details and prompts the first customer 102 to approve the cash-deposit transaction. The first customer 102 may approve or decline the cash-deposit transaction. When the first customer 102 approves the cash-deposit transaction, the currency recycler 106 communicates an approval response (e.g., a funds transfer response) to the acquirer server 108. The acquirer server 108 communicates the approval response to the first issuer server 112 by way of the payment network server 110. On receiving the approval response, the first issuer server 112 initiates the cash-deposit transaction. In one embodiment, when the recipient account is maintained at the first issuer, the first issuer server 112 credits an amount equivalent to the value of the currency bills to the recipient account. In another embodiment, when the recipient account is maintained at another issuer instead of at the first issuer, the first issuer server 112 communicates with the other issuer for crediting the amount to the first recipient account. The currency type of the recipient account may be same or different from the currency type of the currency bills submitted by the first customer 102. The first customer 102 is notified by the service application 118 that the recipient account is successfully credited.

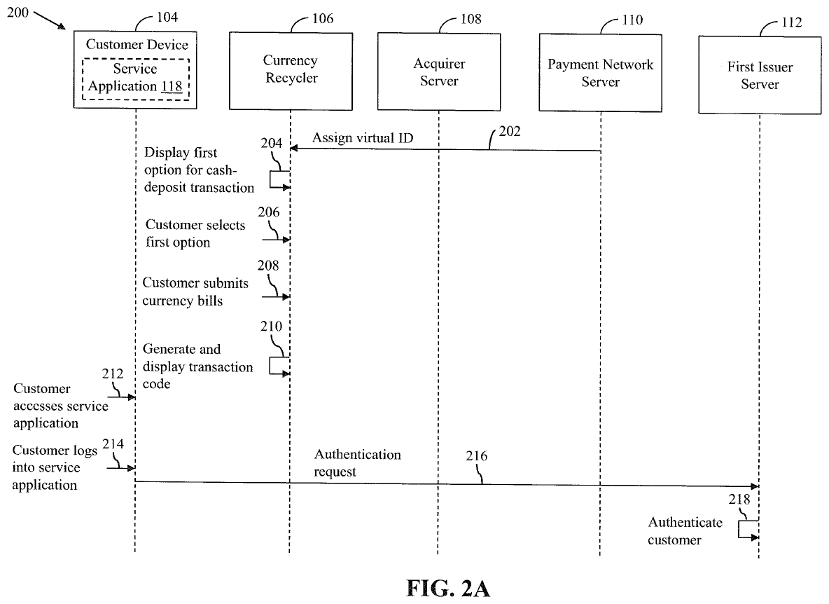

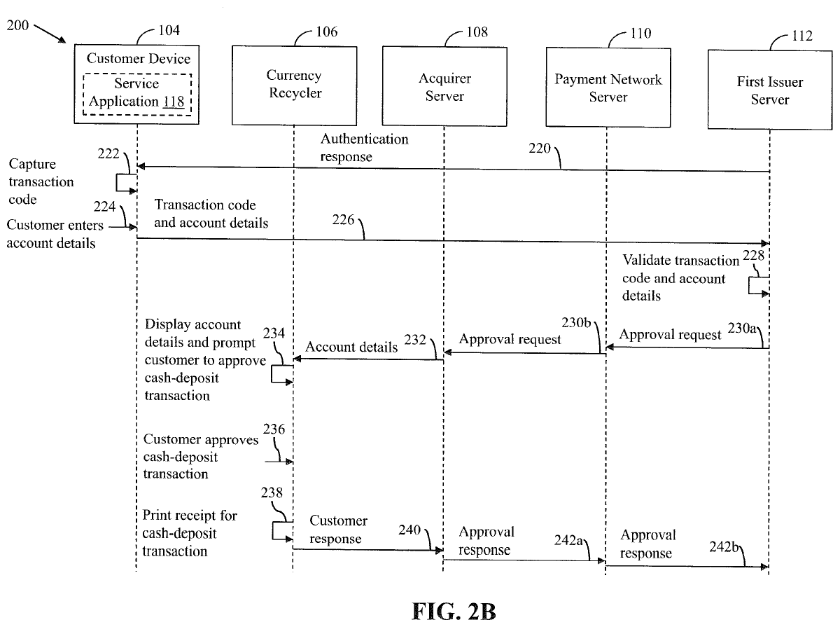

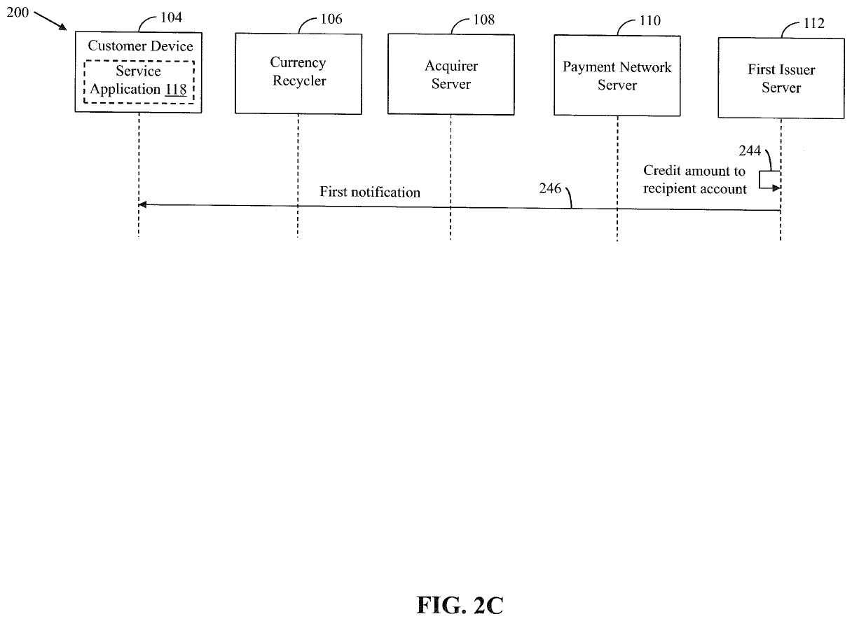

FIGS. 2A-2C, collectively represent a process flow diagram 200 that illustrates an exemplary scenario for facilitating cash-deposit transactions, in accordance with an embodiment of the present invention. The process flow diagram 200 involves the customer device 104, the currency recycler 106, the acquirer server 108, the payment network server 110, the first issuer server 112, and the service application 118.

The payment network server 110 assigns the first virtual ID to the currency recycler 106 (as shown by arrow 202). Likewise, the currency recycler 106 is assigned the second and third virtual IDs by the second and third payment networks. The currency recycler 106 renders a user interface (UI) that displays a first option to customers for performing cash-deposit transactions (as shown by arrow 204).

The first customer 102 approaches the currency recycler 106 and selects the first option to perform a cash-deposit transaction (as shown by arrow 206). After selecting the first option, the first customer 102 submits a first set of currency bills (hereinafter referred to as “the currency bills”) to the currency recycler 106 (as shown by arrow 208). For example, the first customer 102 places a hundred-dollar bill (i.e., $100) and a fifty-dollar bill ($50) in an escrow device (not shown) of the currency recycler 106. In other words, the first customer 102 submits a total of $150 to the currency recycler 106.

The currency recycler 106 verifies authenticity of each currency bill, and determines a currency of the currency bills (here, USD), a denomination of each currency bill, and a total value of the currency bills (i.e., $150). For example, if the currency recycler 106 determines that a currency bill is fake (i.e., not genuine) or in a damaged condition, the currency recycler 106 may return the fake or damaged currency bill to the first customer 102 and proceed with other currency bills that are not fake or damaged. Consequently, the currency recycler 106 generates a first QR code (i.e., a transaction code) and displays the first QR code on the UI (as shown by arrow 210). The first QR code has encoded therein, the value (i.e., $150) of the currency bills, the currency of the currency bills, the first through third virtual IDs of the currency recycler 106, the location identifier of the currency recycler 106, the MCC, a terminal ID of the currency recycler 106, a transaction ID of the cash-deposit transaction, a checksum for validation of the first QR code, or the like.

The first customer 102 accesses the service application 118 installed on the customer device 104 (as shown by arrow 212). The first customer 102 attempts to log into the service application 118 by providing authentication information, such as a username-password combination, a one-time password (OTP), and/or the like (as shown by arrow 214). Based on the username and password entered by the first customer 102, the service application 118 communicates an authentication request to the first issuer server 112 hosting the service application 118 (as shown by arrow 216). The authentication request includes the username and password entered by the first customer 102. The first issuer server 112 authenticates the first customer 102 by verifying the username and password entered by the first customer 102 (as shown by arrow 218). Based on a result of the verification, the first issuer server 112 transmits an authentication response to the service application 118 (as shown by arrow 220). Based on the authentication response, the service application 118 determines whether the first customer 102 is successfully authenticated. If the first customer 102 is successfully authenticated, the login is successful, else the login fails. The service application 118 may request the first customer 102 to re-enter authentication information if the login is unsuccessful. In a non-limiting example, it is assumed that the first customer 102 successfully logs in to the service application 118.

The first customer 102 uses the service application 118 to capture the first QR code displayed by the currency recycler 106 (as shown by arrow 222). For example, the first customer 102 may scan the first QR code by way of the service application 118 using a camera of the customer device 104. Once the first QR code is captured, the service application 118 prompts the first customer 102 to enter account details of the recipient account that is to be credited with an amount equivalent to the value of the currency bills. The first customer 102 enters the account details of the recipient account (as shown by arrow 224). In another embodiment, if the recipient account is already saved with the service application 118, the service application 118 may automatically retrieve the account details of the recipient account and prompt the first customer 102 to confirm the retrieved account details. For the sake of ongoing description of FIGS. 2A-2C, it is assumed that the recipient account is the first digital wallet of the first customer 102 maintained at the first issuer. In one scenario, the first customer 102 may have linked the first digital wallet to the service application 118. In another scenario, the first customer 102 may have created the first digital wallet using the service application 118.

As the service application 118 is a gateway or switch to the first issuer server 112, the first issuer server 112 receives all the information received by the service application 118. Thus, the first issuer server 112 receives the first QR code and the account details of the first digital wallet (as shown by arrow 226). The service application 118 may also communicate the transaction card details of the first transaction card, which is saved with the service application 118, to the first issuer server 112. The first issuer server 112 receives and validates the first QR code and the account details of the first digital wallet (as shown by arrow 228). For validating the first QR code, the first issuer server 112 extracts the information included in the first QR code. In one example, the first issuer server 112 may use a QR code reader to extract the information included in the first QR code and validate it based on the checksum included in the first QR code. For validating the account details of the first digital wallet, the first issuer server 112 may generate an account status inquiry (ASI) request. If it is determined by the first issuer server 112, that any of the account details or the first QR code is invalid, the first issuer server 112 aborts the cash-deposit transaction. Consequently, the first issuer server 112 may transmit a notification to the service application 118, informing the first customer 102 of a failure of the cash-deposit transaction. In a non-limiting example, it is assumed that the first QR code and the account details of the first digital wallet are valid.

The first issuer server 112 identifies the payment network (here, the first payment network) associated with the first transaction card based on the transaction card details received from the service application 118. The first issuer server 112 communicates an approval request (i.e., a funds transfer request) to the payment network server 110 (as shown by arrow 230a). The approval request may include the first virtual ID of the currency recycler 106, the account details of the recipient account, name and address of the account holder of the first digital wallet, or the like. The payment network server 110 transmits the approval request to the acquirer server 108 (as shown by arrow 230b).

The acquirer server 108 communicates the account details of the first digital wallet and the name and address of the account holder to the currency recycler 106, and instructs the currency recycler 106 to prompt the first customer 102 to approve the cash-deposit transaction (as shown by arrow 232). The currency recycler 106 displays the account details of the first digital wallet and the name and address of the account holder on the UI, and prompts the first customer 102 to approve the cash-deposit transaction by selecting a second option displayed on the UI (as shown by arrow 234). The UI further displays a third option for declining the cash-deposit transaction. The first customer 102 may approve or decline the cash-deposit transaction by selecting one of the second or third option. In a non-limiting example, it is assumed that the first customer 102 approves the cash-deposit transaction by selecting the second option (as shown by arrow 236). Based on the selection of the second option by the first customer 102, the currency recycler 106 moves the currency bills from the escrow device to cassettes (not shown) of the currency recycler 106. Consequently, the currency recycler 106 displays a message on the UI, indicating that the cash-deposit transaction has been approved by the first customer 102, and prints a receipt for the cash-deposit transaction (as shown by arrow 238).

The currency recycler 106 communicates, to the acquirer server 108, a customer response indicating the selection of the second option by the first customer 102 (as shown by arrow 240). Based on the customer response, the acquirer server 108 communicates an approval response (i.e., a funds transfer response) to the payment network server 110 (as shown by arrow 242a). The payment network server 110 transmits the approval response to the first issuer server 112 (as shown by arrow 242b). Since the first digital wallet of the first customer 102 is maintained at the first issuer, the first issuer server 112 initiates a credit of the amount (e.g., $150) equivalent to the value of the currency bills to the first digital wallet. Thus, the amount of $150 is credited to the first digital wallet (as shown by arrow 244). Consequently, the first issuer server 112 communicates a first notification to the customer device 104, apprising the first customer 102 of success of the cash-deposit transaction (as shown by arrow 246).

In one embodiment, a currency type (e.g., USD) of the first digital wallet may be same as the currency type (e.g., USD) of the currency bills submitted to the currency recycler 106. In another embodiment, the currency type (e.g., Singapore Dollar, SGD) of the first digital wallet may be different from the currency type (e.g., USD) of the currency bills submitted to the currency recycler 106. Such cross-currency transactions may be facilitated by applying an appropriate currency conversion rate. Thus, the present invention also enables cross-currency cash-deposit transactions. In other words, the first customer 102 is allowed to deposit currency bills of any currency at the currency recycler 106. It will be apparent to a person having ordinary skill in the art that the first acquirer, the first issuer, the payment network, and any other entity involved in the cross-currency cash-deposit transaction may charge a suitable processing fees for processing the cash-deposit transaction.

In another embodiment, the recipient account may be the first bank account, maintained at the first issuer, of the first customer 102. The process of depositing money in the first bank account by way of the service application 118 and the currency recycler 106 is similar to the process described above, as in case of the first digital wallet. In yet another embodiment, the recipient account may be a second digital wallet, which is maintained at the first issuer, of a third-party beneficiary. The process of depositing money in the second digital wallet by way of the service application 118 and the currency recycler 106 is similar to the process described above, as in case of the first digital wallet. In yet another embodiment, the recipient account may be a second bank account, which is maintained at the first issuer, of the third-party beneficiary. The process of depositing money in the second bank account by way of the service application 118 and the currency recycler 106 is similar to the process described above, as in case of the first digital wallet.

In another scenario, the first customer 102 may decline the cash-deposit transaction by selecting the third option displayed on the UI of the currency recycler 106. Based on the selection of the third option by the first customer 102, the currency recycler 106 may not move the currency bills to the cassettes from the escrow, and may return them to the first customer 102. The currency recycler 106 further communicates the customer response indicating the selection of the third option to the acquirer server 108. The acquirer server 108 then communicates the approval response to the first issuer server 112 by way of the payment network server 110. In such a case, the approval response indicates that the first customer 102 has not approved the cash-deposit transaction. Thus, the first issuer server 112 communicates a second notification to the service application 118, apprising the first customer 102 of a failure of the cash-deposit transaction.

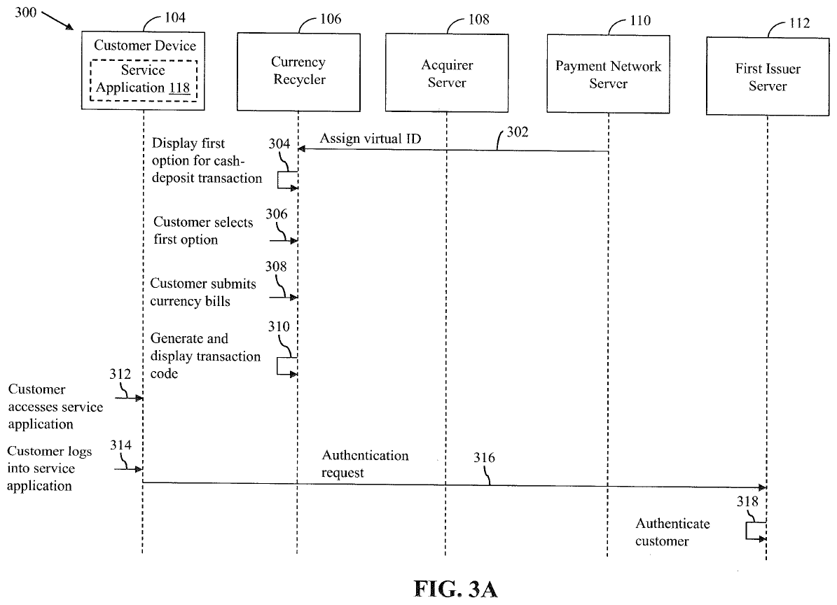

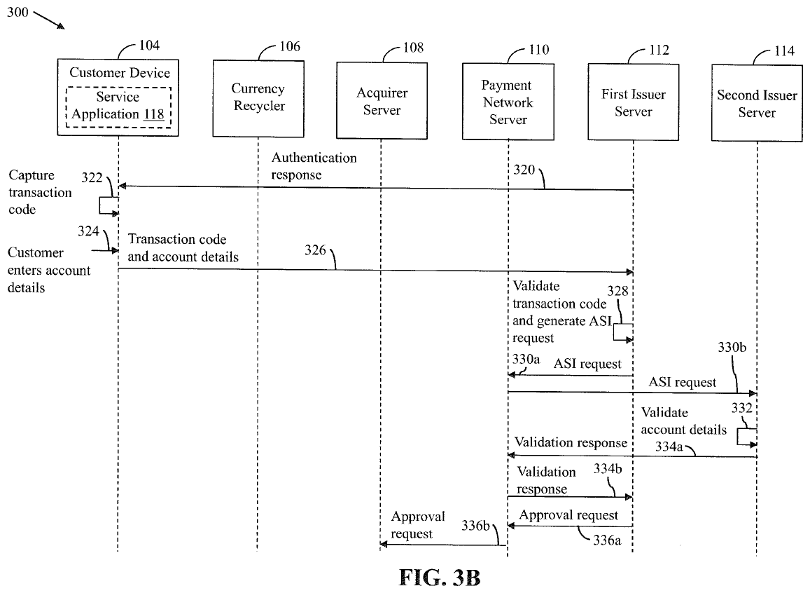

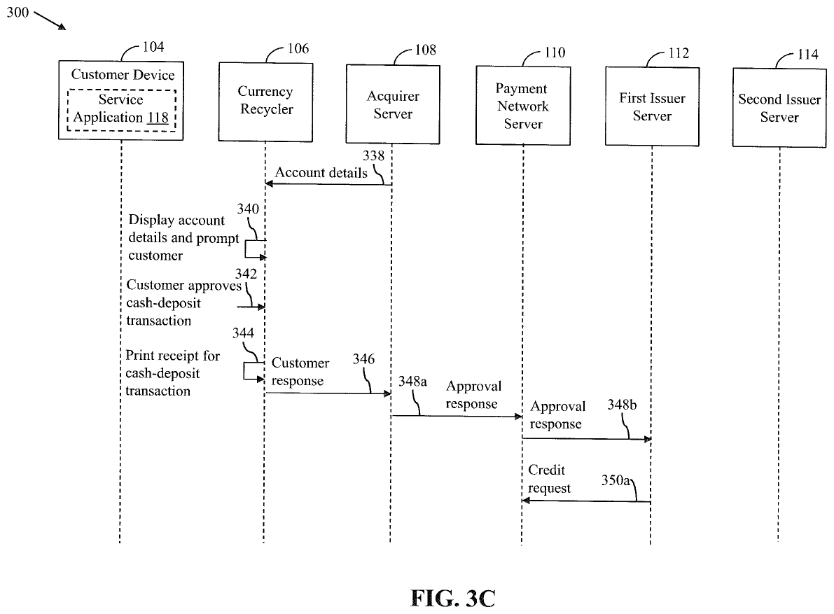

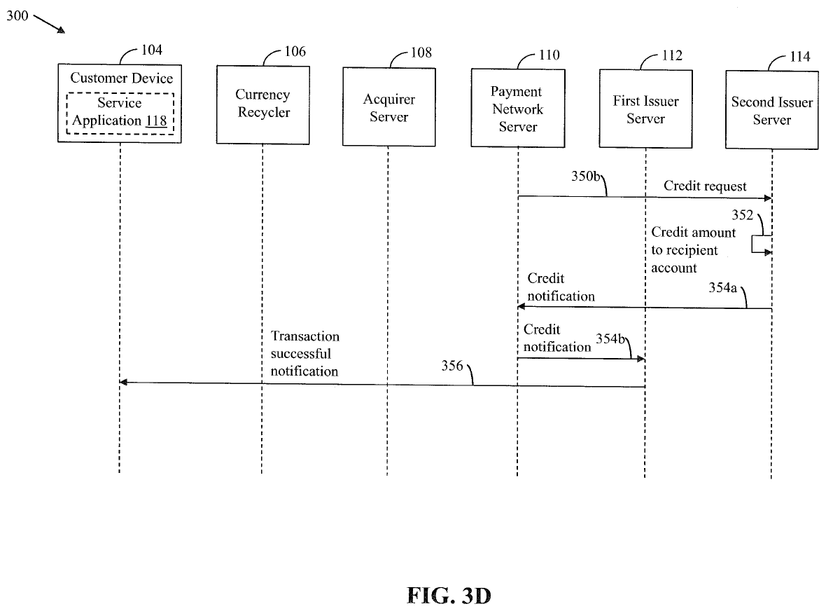

FIGS. 3A-3D, collectively represent a process flow diagram 300 that illustrates another exemplary scenario for facilitating cash-deposit transactions, in accordance with another embodiment of the present invention. The process flow diagram 300 involves the customer device 104, the currency recycler 106, the acquirer server 108, the payment network server 110, the first issuer server 112, the second issuer server 114, and the service application 118.

The payment network server 110 assigns the first virtual ID to the currency recycler 106 (as shown by arrow 302). The currency recycler 106 renders the UI that displays the first option to customers for performing cash-deposit transactions (as shown by arrow 304).

The first customer 102 approaches the currency recycler 106 and selects the first option to perform a cash-deposit transaction (as shown by arrow 306). After selecting the first option, the first customer 102 submits a second set of currency bills (hereinafter, referred to as “the currency bills”) to the currency recycler 106 (as shown by arrow 308). For example, the first customer 102 places two fifty-dollar bills in the escrow device of the currency recycler 106.

The currency recycler 106 verifies authenticity of each currency bill, and determines a currency of the currency bills (here, USD), a denomination of each currency bill, and a total value of the currency bills (i.e., $100). Consequently, the currency recycler 106 generates a second QR code (i.e., a transaction code) and displays the second QR code on the UI (as shown by arrow 310). The second QR code has encoded therein, the value (i.e., $100) of the currency bills, the currency of the currency bills, the first through third virtual IDs of the currency recycler 106, the location identifier of the currency recycler 106, the MCC, the terminal ID of the currency recycler 106, a transaction ID of the cash-deposit transaction, a checksum for validation of the second QR code, or the like.

The first customer 102 accesses the service application 118 installed on the customer device 104 (as shown by arrow 312). The first customer 102 attempts to log into the service application 118 (as shown by arrow 314). The service application 118 communicates an authentication request to the first issuer server 112 hosting the service application 118 (as shown by arrow 316). The authentication request includes the username and password entered by the first customer 102. The first issuer server 112 authenticates the first customer 102 (as shown by arrow 318). The first issuer server 112 transmits an authentication response to the service application 118 (as shown by arrow 320). If the first customer 102 is successfully authenticated, the login is successful, else the login fails. In a non-limiting example, it is assumed that the first customer 102 successfully logs into the service application 118.

The first customer 102 then uses the service application 118 to capture the second QR code displayed by the currency recycler 106 (as shown by arrow 322). Once the second QR code is captured, the service application 118 prompts the first customer 102 to enter account details of the recipient account that is to be credited with an amount (i.e., $100) equivalent to the value of the currency bills. The first customer 102 enters the account details of the recipient account (as shown by arrow 324). For the sake of ongoing description of FIGS. 3A-3D, it is assumed that the recipient account is a third digital wallet of the first customer 102 maintained at the second issuer which is different from the first issuer.

As the service application 118 is a gateway or switch to the first issuer server 112, the first issuer server 112 receives the information received by the service application 118. Thus, the first issuer server 112 receives the second QR code and the account details of the third digital wallet (as shown by arrow 326). The service application 118 may also communicate transaction card details of the first transaction card, which is saved with the service application 118, to the first issuer server 112. The first issuer server 112 receives and validates the second QR code and generates the ASI request (as shown by arrow 328). The ASI request includes the account details of the third digital wallet. Since the third digital wallet is not maintained at the first issuer, the first issuer server 112 identifies the second issuer that maintains the third digital wallet through the payment network that corresponds to the cash-deposit transaction. The first issuer server 112 then communicates the ASI request to the second issuer server 114 by way of the payment network server 110 (as shown by arrows 330a and 330b). The second issuer server 114 validates the account details of the third digital wallet based on the ASI request (as shown by arrow 332). In a non-limiting example, it is assumed that the account details of the third digital wallet are valid. The second issuer server 114 communicates a validation response to the first issuer server 112 by way of the payment network server 110 (as shown by arrows 334a and 334b). The validation response indicates that the account details of the third digital wallet are valid.

Based on the validation response, the first issuer server 112 communicates an approval request (i.e., the funds transfer request) to the payment network server 110 (as shown by arrow 336a). The payment network server 110 transmits the approval request to the acquirer server 108 (as shown by arrow 336b). The acquirer server 108 communicates the account details of the third digital wallet and the name and address of the account holder to the currency recycler 106, and instructs the currency recycler 106 to prompt the first customer 102 to approve the cash-deposit transaction (as shown by arrow 338). The currency recycler 106 displays the account details of the third digital wallet and the name and address of the account holder on the UI, and prompts the first customer 102 to approve the cash-deposit transaction by selecting the second option displayed on the UI (as shown by arrow 340). In a non-limiting example, it is assumed that the first customer 102 approves the cash-deposit transaction by selecting the second option (as shown by arrow 342). Based on the selection of the second option by the first customer 102, the currency recycler 106 moves the currency bills from the escrow device to the cassettes within the currency recycler 106. Consequently, the currency recycler 106 displays a message on the UI, indicating that the cash-deposit transaction has been approved by the first customer 102, and prints a receipt for the cash-deposit transaction (as shown by arrow 344).

The currency recycler 106 communicates, to the acquirer server 108, a customer response indicating the selection of the second option by the first customer 102 (as shown by arrow 346). Based on the customer response, the acquirer server 108 communicates an approval response (i.e., the funds transfer response) to the payment network server 110 (as shown by arrow 348a). The payment network server 110 transmits the approval response to the first issuer server 112 (as shown by arrow 348b). The first issuer server 112 generates a credit request to credit the third digital wallet with the amount (e.g., $100) equivalent to the value of the currency bills. The credit request includes the account details of the third digital wallet (i.e., the third digital wallet) and the value of the currency bills. The first issuer server 112 communicates the credit request to the payment network server 110 (as shown by arrow 350a) and the payment network server 110 communicates the credit request to the second issuer server 114 (as shown by arrow 350b). The second issuer server 114 credits the amount equivalent to the value of the currency bills to the third digital wallet based on the credit request (as shown by arrow 352). Consequently, the second issuer server 114 transmits a credit notification to the first issuer server 112 by way of the payment network server 110 (as shown by arrows 354a and 354b). The credit notification indicates that the third digital wallet is successfully credited with the amount equivalent to the value of the currency bills. Based on the credit notification, the first issuer server 112 transmits the first notification to the customer device 104 (as shown by arrow 356).

In another embodiment, the recipient account may be a third bank account, maintained at the second issuer, of the first customer 102. The process of depositing money in the third bank account by way of the service application 118 and the currency recycler 106 is similar to the process described above, as in case of the third digital wallet. In yet another embodiment, the recipient account may be a fourth digital wallet, which is maintained at the second issuer, of a third-party beneficiary. The process of depositing money in the fourth digital wallet by way of the service application 118 and the currency recycler 106 is similar to the process described above, as in case of the third digital wallet. In yet another embodiment, the recipient account may be a fourth bank account, which is maintained at the second issuer, of the third-party beneficiary. The process of depositing money in the fourth bank account by way of the service application 118 and the currency recycler 106 is similar to the process described above, as in case of the third digital wallet.

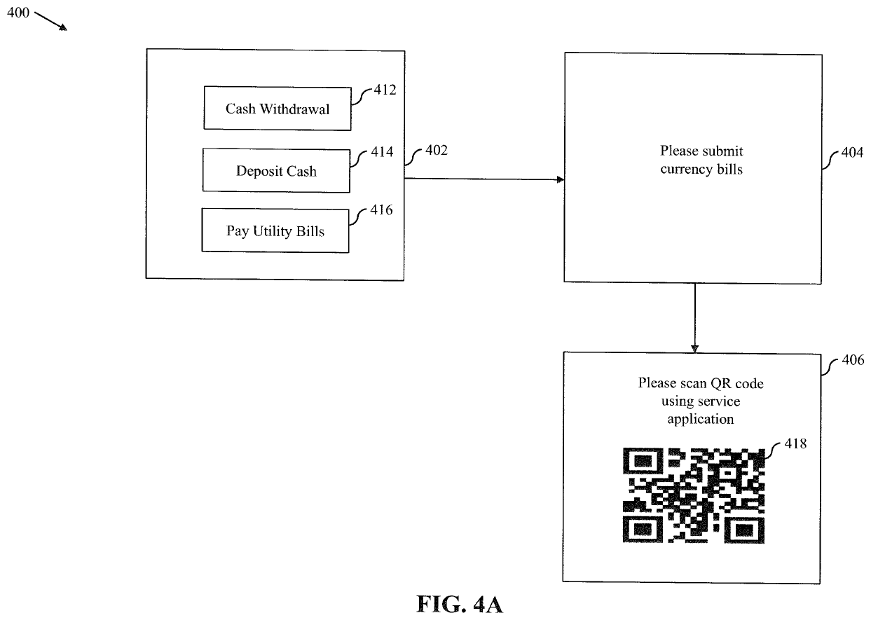

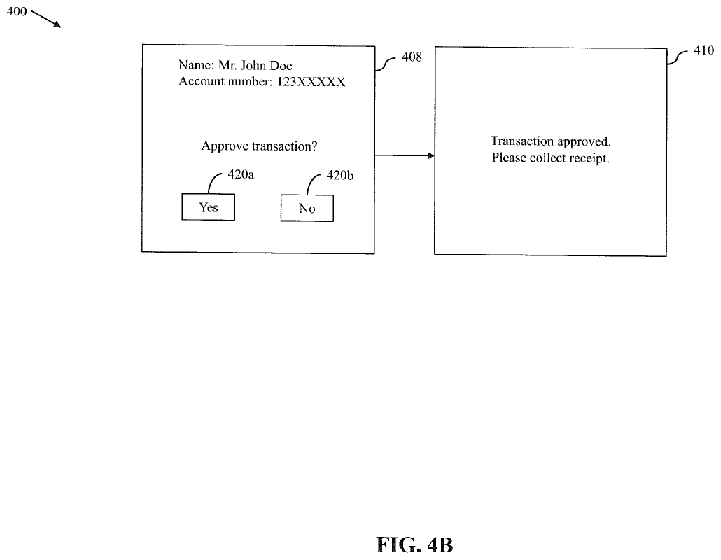

FIGS. 4A and 4B represent an exemplary scenario 400 that illustrates first through fifth UI screens 402, 404, 406, 408, and 410 rendered by the currency recycler 106, in accordance with an embodiment of the present invention. The UI screens 402-410 are rendered on a display (not shown) of the currency recycler 106.

With reference to FIG. 4A, when the first customer 102 approaches the currency recycler 106, the UI screen 402 is displayed by the currency recycler 106. The UI screen 402 includes first through third customer-selectable options 412, 414, and 416. The first through third customer-selectable options 412, 414, and 416 allow the first customer 102 to withdraw cash, deposit money, and pay utility bills, respectively. When the first customer 102 selects the second customer-selectable option 414 to perform a cash-deposit transaction, the UI screen 404 is displayed by the currency recycler 106. The UI screen 404 presents a first message requesting the first customer 102 to submit currency bills. The first customer 102 submits the currency bills to the currency recycler 106. After receiving the currency bills, the currency recycler 106 generates a transaction code 418 (e.g., the first or second QR code), as described in the foregoing description of FIGS. 2A and 3A. The currency recycler 106 renders the UI screen 406 to present the transaction code 418 to the first customer 102. The UI screen 406 includes a second message requesting the first customer 102 to scan the transaction code 418 using the service application 118.

The first customer 102 scans the transaction code 418 by using the service application 118 and enters the account details of the recipient account in the service application 118. The first issuer server 112 receives the transaction code 418 and the account details of the recipient account from the service application 118. The first issuer server 112 then communicates the approval request to the acquirer server 108 by way of the payment network server 110. The acquirer server 108 instructs the currency recycler 106 to display the account details of the recipient account and prompt the first customer 102 to approve the cash-deposit transaction.

With reference to FIG. 4B, the currency recycler 106 displays the UI screen 408 based on the instructions of the acquirer server 108. The UI screen 408 displays the account details of the recipient account (e.g., customer name, ‘John Doe’ and account number ‘123xxxxx’). The UI screen 408, further, includes fourth and fifth customer-selectable options 420a and 420b. The fourth and fifth customer-selectable options 420a and 420b allow the first customer 102 to approve or decline the cash-deposit transaction, respectively. When the first customer 102 approves the cash-deposit transaction by selecting the fourth customer-selectable option 420a, the currency recycler 106 displays the UI screen 410 and prints a receipt for the cash-deposit transaction. The UI screen 410 includes a third message that indicates that the cash-deposit transaction is approved and requests the first customer 102 to collect the receipt.

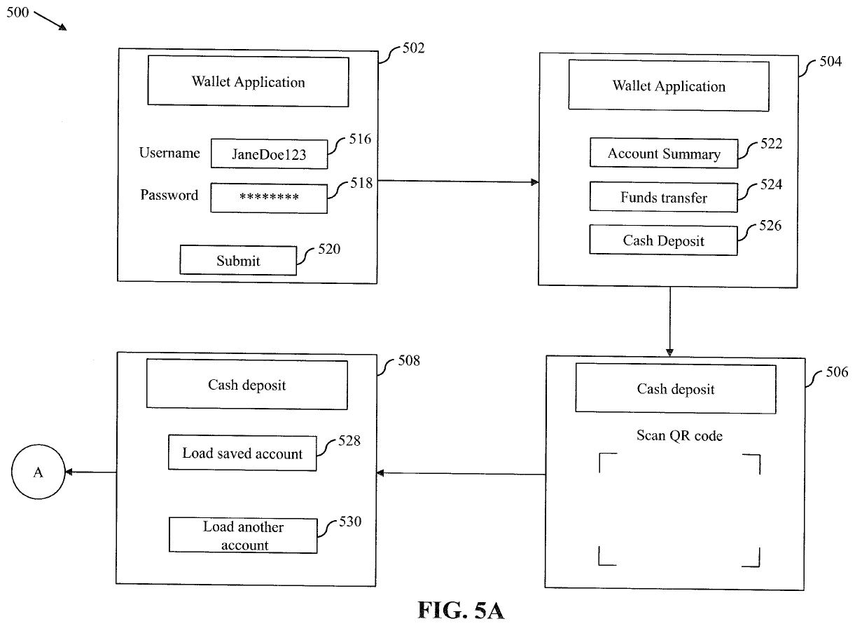

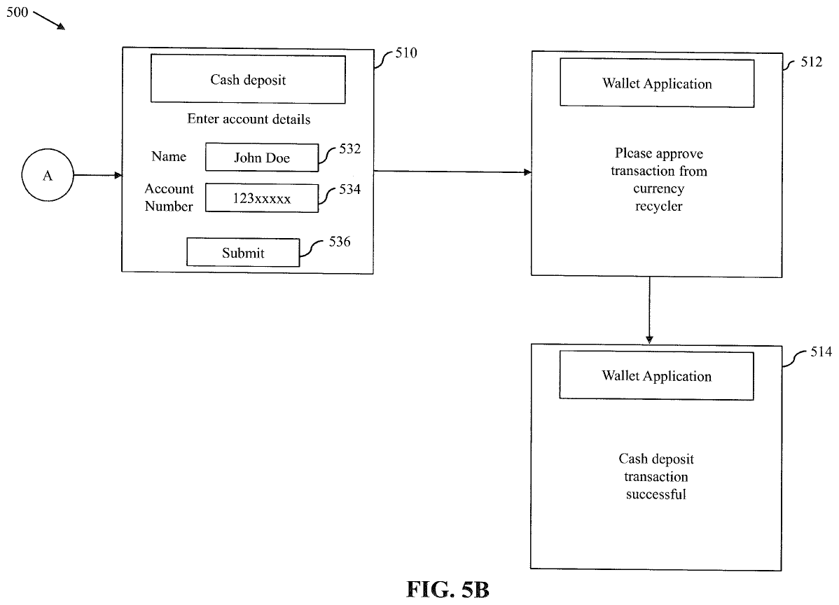

FIGS. 5A and 5B represent an exemplary scenario 500 that illustrates sixth through twelfth UI screens 502, 505, 506, 508, 510, 512, and 514 that are rendered on a display of the customer device 104, in accordance with an embodiment of the present invention. The UI screens 502-514 represent an interactive interface of the service application 118. The first customer 102 may have already signed up for the service application 118 by providing a username and a password, as known to those skilled in the art.

With reference to FIG. 5A, when the first customer 102 accesses the service application 118 (e.g., a wallet application), the UI screen 502 is rendered on the display of the customer device 104. The UI screen 502 presents first and second text boxes 516 and 518, which allow the first customer 102 to enter her username (here, ‘JaneDoe123’) and password, respectively, for logging into the service application 118. The UI screen 502 further presents a first submit button 520, which is selectable by the first customer 102. The first customer 102 enters her username and password in the first and second text boxes 516 and 518, respectively, and selects the first submit button 520. The service application 118 serves as a gateway to the first issuer server 112, and therefore the username and password entered by the first customer 102 are communicated to the first issuer server 112.

If the first customer 102 is successfully authenticated by the first issuer server 112, the UI screen 504 is rendered on the display of the customer device 104. The UI screen 504 presents sixth through eighth customer-selectable options 522, 524, and 526. The sixth through eighth customer-selectable options 522, 524, and 526 allow the first customer 102 to view an account summary of the first customer account, transfer funds, and perform the cash-deposit transaction, respectively. When the first customer 102 selects the eighth customer-selectable option 526, the UI screen 506 is rendered on the display of the customer device 104. The UI screen 506 includes a fourth message requesting the first customer 102 to scan the transaction code 418 displayed by the currency recycler 106.

The first customer 102 scans, by using the service application 118, the transaction code 418 displayed on the currency recycler 106. When the transaction code 418 is captured, the UI screen 508 is rendered on the display of the customer device 104. The UI screen 508 includes ninth and tenth customer-selectable options 528 and 530. The ninth customer-selectable option 528, when selected, allows the first customer 102 to load a linked recipient account with the amount equivalent to the value of the currency bills submitted to the currency recycler 106. The tenth customer-selectable option 530, when selected, allows the first customer 102 to load a recipient account, which is not saved with the service application 118, with the amount equivalent to the value of the currency bills submitted to the currency recycler 106.

With reference to FIG. 5B, when the first customer 102 selects any of the ninth and tenth customer-selectable options 528 and 530, the UI screen 510 is rendered on the display of the customer device 104. The UI screen 510 includes third and fourth text boxes 532 and 534 which allow the first customer 102 to enter the account details (e.g., name, ‘John Doe’ and the account number, ‘123xxxxx’) of the account that is to be credited. The UI screen 510 further includes a second submit button 536 that is selectable by the first customer 102. In one embodiment, when the recipient account is already saved with the service application 118 and the first customer 102 selects the ninth customer-selectable option 528, the third and fourth text boxes 532 and 534 may be automatically populated with the account details. The first customer 102 selects the second submit button 536 after entering the account details in the third and fourth text boxes 532 and 534. The service application 118 communicates the scanned transaction code 418 and the submitted account details to the first issuer server 112.

Consequently, the UI screen 512 is rendered on the display of the customer device 104. The UI screen 512 includes a fifth message, requesting the first customer 102 to approve the cash-deposit transaction by way of the currency recycler 106 and the acquirer server 108. On successful completion of the cash-deposit transaction, the UI screen 514 is rendered on the display of the customer device 104. The UI screen 514 presents a sixth message that indicates the cash-deposit transaction is successful.

It will be apparent to a person having ordinary skill in the art that the abovementioned UI screens 402-410 and 502-514 are shown for illustrative purpose and should not be construed to limit the scope of the invention.

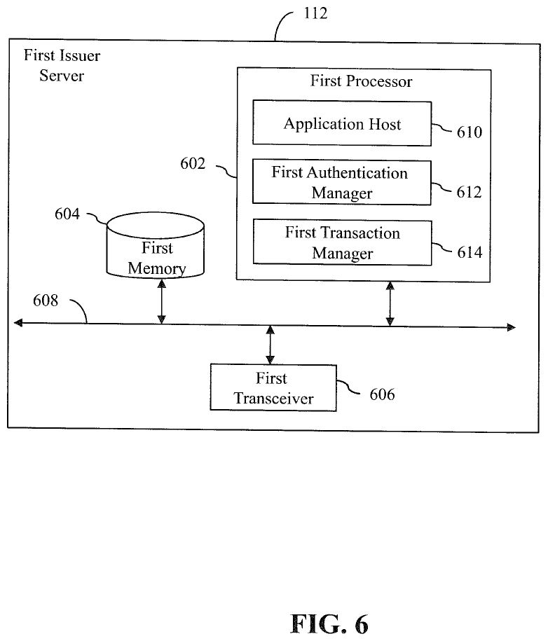

FIG. 6 is a block diagram that illustrates the first issuer server 112, in accordance with an embodiment of the present invention. The first issuer server 112 includes a first processor 602, a first memory 604, and a first transceiver 606. The first processor 602, the first memory 604, and the first transceiver 606 communicate with each other by way of a first communication bus 608. The first processor 602 includes an application host 610, a first authentication manager 612, and a first transaction manager 614. It will be apparent to those of skill in the art that the second issuer server 114 is functionally similar to the first issuer server 112.

The first processor 602 includes suitable logic, circuitry, and/or interfaces to process cash-deposit transactions performed by the first customer 102 at the currency recycler 106. The first processor 602 stores, in the first memory 604, the account profile of the first customer 102. The account profile of the first customer 102 includes the account details (such as an account balance of the first customer account, a transaction history of the first customer 102, or the like) of the first customer account, authentication information (such as the username and password of the first customer 102 for accessing the service application 118) of the first customer 102, and/or the like. The first processor 602 hosts the service application 118 that is accessed by the first customer 102 for performing the cash-deposit transaction. The first processor 602 authenticates the first customer 102 when the first customer 102 accesses the service application 118 and attempts to log into the service application 118.

The first processor 602, further, generates and communicates the approval request, receives the approval response, and initiates the crediting of the recipient account based on the cash-deposit transaction. Examples of the first processor 602 include, but are not limited to, an application-specific integrated circuit (ASIC) processor, a reduced instruction set computer (RISC) processor, a complex instruction set computer (CISC) processor, a field programmable gate array (FPGA), and the like. The first processor 602 executes the operations for processing the cash-deposit transactions by way of the first authentication manager 612 and the first transaction manager 614.

The application host 610 executes operations for hosting the service application 118 that is executable on various devices, such as the customer device 104. The application host 610 controls the service application 118 and causes it to perform various operations (such as the rendering of the UI screens 502-514) as described in FIGS. 2A-2C, 3A-3D, and 5A-5B. The application host 610 receives the data and information (such as the transaction card details, the account details of the recipient account) that customers (such as the first customer 102) enter through the UI screens 502-514 rendered by the service application 118 and stores it in the first memory 604.

The first authentication manager 612 authenticates customers (such as the first customer 102) who attempt to log into the service application 118. The first authentication manager 612 receives the authentication request from the service application 118. The first authentication manager 612 verifies whether the authentication information (such as the username and password) entered by the first customer 102 is valid. The first authentication manager 612 compares the username and password provided by the first customer 102 with the username and password stored in the account profile of the first customer 102. The first customer 102 is authenticated if the username and password provided by the first customer 102 match the username and password, respectively, stored in the account profile of the first customer 102. The first authentication manager 612 validates the authentication information by using various validation and verification techniques known in the art. Based on a result of the comparison, the first authentication manager 612 generates the authentication response.

The first transaction manager 614 processes cash-deposit transactions performed by customers (such as the first customer 102) at the currency recycler 106. The first transaction manager 614 receives the transaction code 418, the account details of the recipient account, and the transaction card details of the first transaction card from the service application 118. The first transaction manager 614 validates the transaction code 418 and the account details of the recipient account (as described in the foregoing descriptions of FIGS. 2B and 3B). Based on the validation of the transaction code 418 and the account details of the recipient account, the first transaction manager 614 generates the approval request.

As described in the foregoing descriptions of FIGS. 2C and 3C, the first transaction manager 614 receives the approval response. Based on the approval response, the first transaction manager 614 may generate the ASI request and credit the recipient account. If the recipient account is maintained by another issuer (such as the second issuer), the first transaction manager 614 communicates with the other issuer to credit the recipient account. Consequently, the first transaction manager 614 transmits the first notification to the customer device 104 to indicate the successful completion of the cash-deposit transaction. If the first customer 102 declines the cash-deposit transaction, the first transaction manager 614 aborts the cash-deposit transaction and transmits the second notification to the customer device 104 indicating the failure of the cash-deposit transaction.

The first memory 604 includes suitable logic, circuitry, and/or interfaces to store the account profiles of the customer accounts (such as the first customer account) that are maintained at the first issuer. The first memory 604 further stores virtual IDs (such as the first through third virtual IDs) assigned by payment networks (such as the first through third payment networks). Examples of the first memory 604 include a random-access memory (RAM), a read-only memory (ROM), a removable storage drive, a hard disk drive (HDD), a flash memory, a solid-state memory, and the like. It will be apparent to a person skilled in the art that the scope of the invention is not limited to realizing the first memory 604 in the first issuer server 112, as described herein. In another embodiment, the first memory 604 may be realized in form of a database server or a cloud storage working in conjunction with the first issuer server 112, without departing from the scope of the invention.

The first transceiver 606 transmits and receives data over the communication network 116 using one or more communication network protocols. The first transceiver 606 transmits various requests and messages to the customer device 104, the currency recycler 106, the acquirer server 108, the payment network server 110, the second issuer server 114, the service application 118, or other entities that are pursuant to one or more standards for the interchange of transaction messages, such as the ISO8583 standard. The first transceiver 606 further receives various requests and messages from the customer device 104, the currency recycler 106, the acquirer server 108, the payment network server 110, the second issuer server 114, and/or the service application 118. Examples of the first transceiver 606 include, but are not limited to, an antenna, a radio frequency transceiver, a wireless transceiver, a Bluetooth transceiver, an ethernet port, a universal serial bus (USB) port, or any other device configured to transmit and receive data.

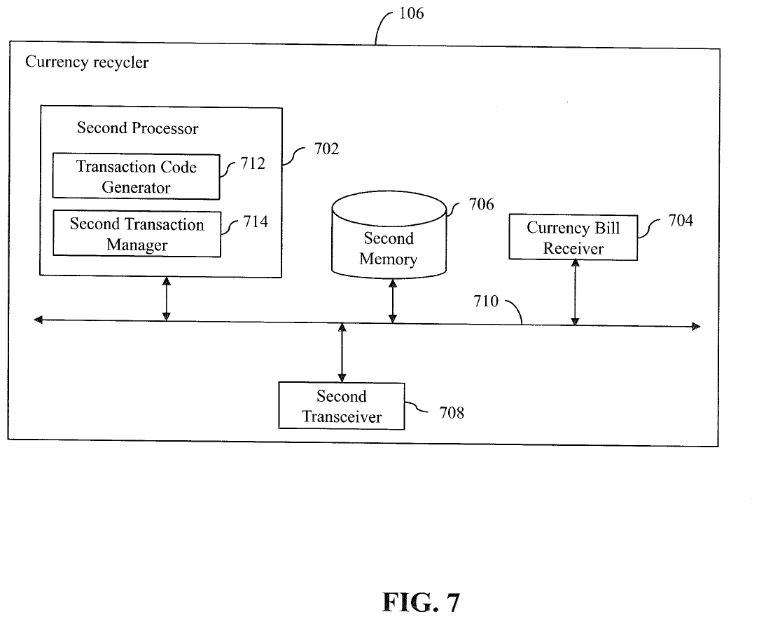

FIG. 7 is a block diagram that illustrates the currency recycler 106, in accordance with an embodiment of the present invention. The currency recycler 106 includes a second processor 702, a currency bill receiver 704, a second memory 706, and a second transceiver 708. The second processor 702, the currency bill receiver 704, and the second transceiver 708 communicate with each other by way of a second communication bus 710. The second processor 702 includes a transaction code generator 712 and a second transaction manager 714.

The second processor 702 includes suitable logic, circuitry, and/or interfaces to facilitate cash-deposit transactions performed by customers (such as the first customer 102) at the currency recycler 106. The second processor 702 renders UI screens (such as the UI screens 402-410 described in the foregoing descriptions of FIGS. 4A and 4B) to facilitate the cash-deposit transactions. The second processor 702 allows the first customer 102 to perform the cash-deposit transaction when the first customer 102 selects the second customer-selectable option 414 to deposit money. The second processor 702, by way of various mechanisms included in the currency recycler 106, instructs the currency bill receiver 704 to accept the currency bills submitted by the first customer 102 to the currency recycler 106. The second processor 702 generates and displays the transaction code 418 (i.e., the first or second QR code), when the first customer 102 submits the currency bills.

Examples of the second processor 702 include, but are not limited to, an ASIC processor, a RISC processor, a CISC processor, an FPGA, and the like. The second processor 702 executes the operations for processing the cash-deposit transactions by way of the currency bill receiver 704, the transaction code generator 712, and the second transaction manager 714.

The currency bill receiver 704 includes suitable logic, circuitry, and/or interfaces for receiving currency bills submitted by customers (such as the first customer 102) for performing the cash-deposit transactions. The currency bill receiver 704 determines the currency and the value of the currency bills. The currency bill receiver 704 determines the denomination of each currency bill. The currency bill receiver 704 determines whether any currency bill is fake or damaged. If the currency bill receiver 704 determines that a currency bill is damaged or fake, the currency bill receiver 704 returns the fake or damaged currency bill to the first customer 102.

The transaction code generator 712 generates transaction codes (such as the first and second QR code, or the transaction code 418) for cash-deposit transactions. The transaction code 418 generated by the transaction code generator 712 may include various fields. For example, when the transaction code 418 is a QR code, the various fields are used to indicate a QR version number of the transaction code 418, an indicator indicating whether the transaction code 418 is static or dynamic, a merchant ID, an MCC of the currency recycler 106, a transaction currency code that indicates the currency of the submitted currency bills, and the value of the submitted currency bills. The various fields further indicate the location identifier of the currency recycler 106, the first virtual through third virtual IDs of the currency recycler 106, a reference ID of the cash-deposit transaction, or the like. The transaction code generator 712 displays the transaction code 418 on the first display of the currency recycler 106. The first customer 102 captures the transaction code 418 by way of the service application 118.

The second transaction manager 714 facilitates the cash-deposit transaction. The second transaction manager 714 receives the account details of the recipient account from the acquirer server 108. The second transaction manager 714 displays the account details of the recipient account on the first display and prompts the first customer 102 to approve the cash-deposit transaction. If the first customer 102 declines the cash-deposit transaction, the second transaction manager 714 returns the currency bills to the first customer 102 by way of the various mechanisms included in the currency recycler 106. The second transaction manager 714, further, communicates a message to the acquirer server 108, indicating that the first customer 102 has declined the cash-deposit transaction. If the first customer 102 approves the cash-deposit transaction, the second transaction manager 714 moves the currency bills to the cassettes and prints the receipt for the first customer 102. The second transaction manager 714 communicates a message to the acquirer server 108, indicating that the first customer 102 has approved the cash-deposit transaction.

The second memory 706 includes suitable logic, circuitry, and/or interfaces to generate transaction codes (such as the transaction code 418) for cash-deposit transactions. The second memory 706, further, stores the first through third virtual IDs, the location identifier of the currency recycler 106, and/or the like. Examples of the second memory 706 include a RAM, a ROM, a removable storage drive, an HDD, a flash memory, a solid-state memory, and the like. It will be apparent to a person skilled in the art that the scope of the invention is not limited to realizing the second memory 706 in the currency recycler 106, as described herein. In another embodiment, the second memory 706 may be realized in form of a database server or a cloud storage working in conjunction with the currency recycler 106, without departing from the scope of the invention.

The second transceiver 708 transmits and receives data over the communication network 116 using one or more communication network protocols. The second transceiver 708 transmits various requests and messages to the acquirer server 108 and/or other entities that are pursuant to one or more standards for the interchange of transaction messages, such as the ISO8583 standard. The second transceiver 708 further receives various requests and messages from the acquirer server 108 and/or other entities that are pursuant to one or more standards for the interchange of transaction messages, such as the ISO8583 standard. Examples of the second transceiver 708 include, but are not limited to, an antenna, a radio frequency transceiver, a wireless transceiver, a Bluetooth transceiver, an ethernet port, a USB port, or any other device configured to transmit and receive data.

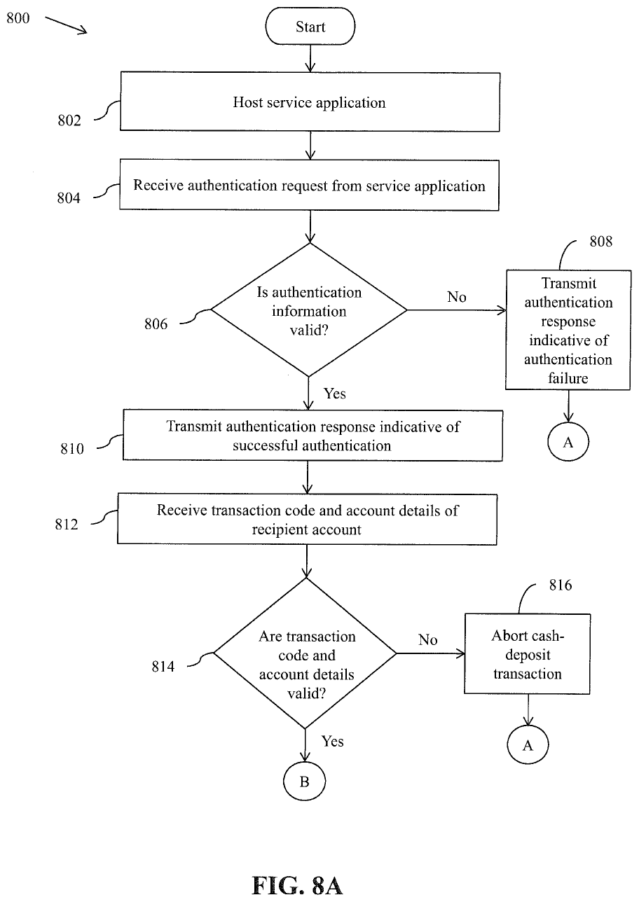

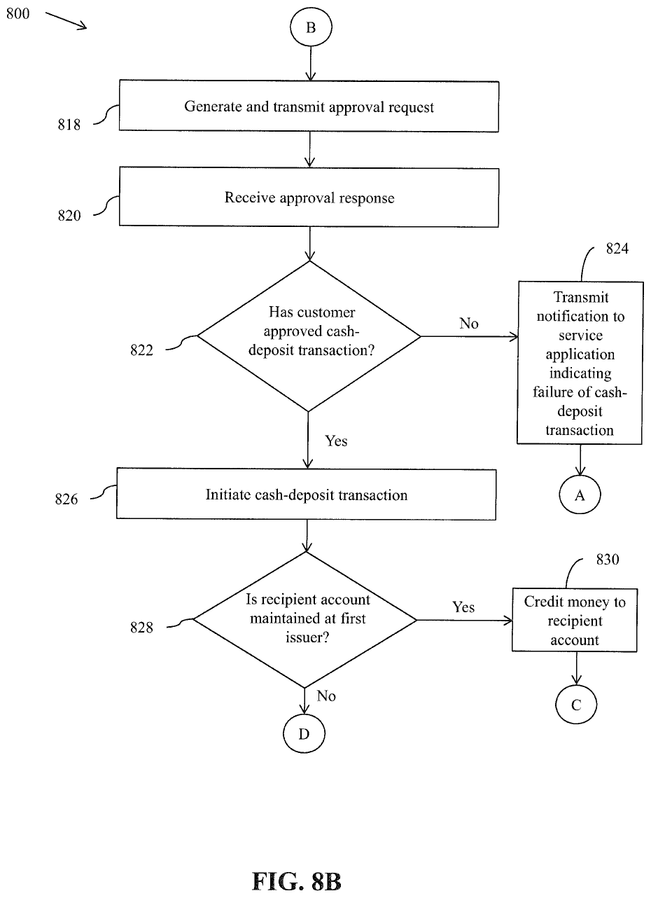

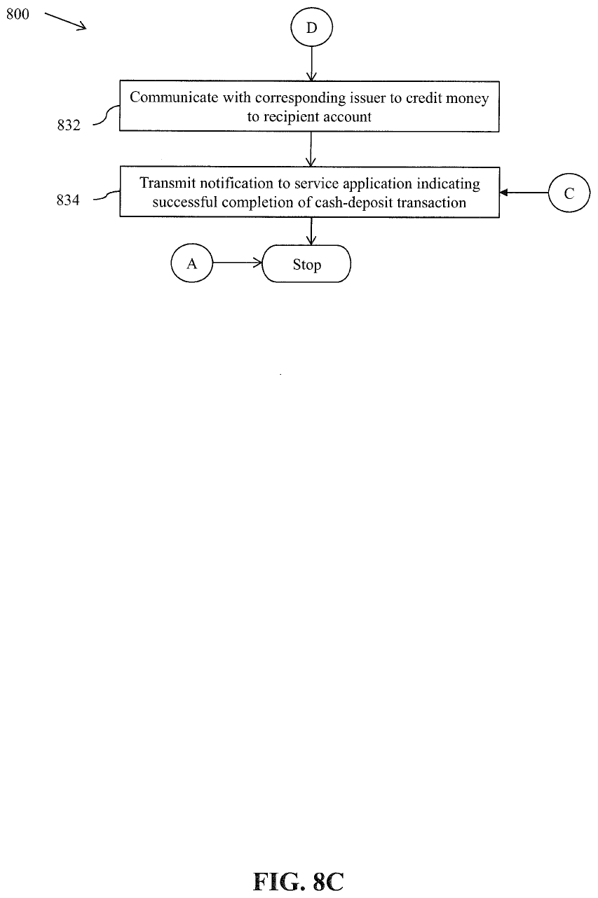

FIGS. 8A-8C, collectively represent a flow chart 800 that illustrates a method for facilitating cash-deposit transactions, in accordance with an embodiment of the present invention. The first customer 102 approaches the currency recycler 106, selects the second customer-selectable option 414 to perform a cash-deposit transaction, and submits the currency bills to the currency recycler 106. The currency recycler 106 displays the transaction code 418 on the display of the currency recycler 106.

At step 802, the first issuer server 112 hosts the service application 118. The first customer 102 accesses the service application 118 and enters the authentication information (i.e., her username and password) to log into the service application 118. The service application 118 generates and transmits the authentication request to the first issuer server 112. The authentication request includes the authentication information (i.e., the username and password) entered by the first customer 102. At step 804, the first issuer server 112 receives the authentication request. At step 806, the first issuer server 112 checks whether the authentication information entered by the first customer 102 is valid. If at step 806, it is determined that the authentication information entered by the first customer 102 is not valid, step 808 is performed. At step 808, the first issuer server 112 transmits the authentication response to the service application 118. The authentication response indicates that the first customer 102 is not authenticated. Therefore, the service application 118 does not allow the first customer 102 to log into the service application 118. If at step 806, it is determined that the authentication information entered by the first customer 102 is valid, step 810 is performed. At step 810, the first issuer server 112 transmits the authentication response to the service application 118. The authentication response indicates that the first customer 102 is successfully authenticated. The first customer 102 logs into the service application 118. The first customer 102 then captures the transaction code 418 by way of the service application 118. The first customer 102, further, enters the account details of the recipient account in the service application 118. At step 812, the first issuer server 112 receives the transaction code 418, the account details of the recipient account, and the transaction card details of the first transaction card from the service application 118.

At step 814, the first issuer server 112 determines whether the transaction code 418 and the account details of the recipient account are valid. If at step 814, it is determined that the transaction code 418 or the account details of the recipient account is not valid, step 816 is performed. At step 816, the first issuer server 112 aborts the cash-deposit transaction. If at step 814, it is determined that the transaction code 418 and the account details of the recipient account are valid, step 818 is performed. At step 818, the first issuer server 112 generates the approval request and transmits the approval request to the payment network server 110 that corresponds to the first transaction card of the first customer 102. The approval request includes the account details of the recipient account and the first virtual ID of the currency recycler 106. The payment network server 110 transmits the approval request to the acquirer server 108. The acquirer server 108 communicates the account details of the recipient account to the currency recycler 106 and instructs the currency recycler 106 to display the account details to the first customer 102 for approval. The currency recycler 106 displays the account details of the recipient account and prompts the first customer 102 to approve the cash-deposit transaction. The first customer 102 may approve or decline the cash-deposit transaction. The currency recycler 106 communicates, to the acquirer server 108, a message indicating whether the first customer 102 has approved or declined the cash-deposit transaction. Based on the message, the acquirer server 108 generates and transmits the approval response to the first issuer server 112 by way of the payment network server 110.

At step 820, the first issuer server 112 receives the approval response. At step 822, the first issuer server 112 determines, based on the approval response, whether the first customer 102 has approved the cash-deposit transaction. If at step 822, it is determined that the first customer 102 has not approved the cash-deposit transaction, step 824 is performed. At step 824, the first issuer server 112 transmits the second notification to the service application 118, indicating that the cash-deposit transaction has failed. If at step 822, it is determined that the first customer 102 has approved the cash-deposit transaction, step 826 is performed. At step 826, the first issuer server 112 initiates the cash-deposit transaction. At step 828, the first issuer server 112 determines if the recipient account is maintained at the first issuer. If at step 828, it is determined that the recipient account is maintained at the first issuer, step 830 is performed. At step 830, the first issuer server 112 credits the recipient account with an amount equivalent to the value of submitted currency bills. If at step 828, it is determined that the recipient account is not maintained at the first issuer, step 832 is performed. At step 832, the first issuer server 112 communicates with the second issuer server 114 to credit the recipient account (as described in the foregoing descriptions of FIGS. 2B and 3D). At step 834, the first issuer server 112 transmits the first notification to the service application 118 to indicate that the cash-deposit transaction is successful.

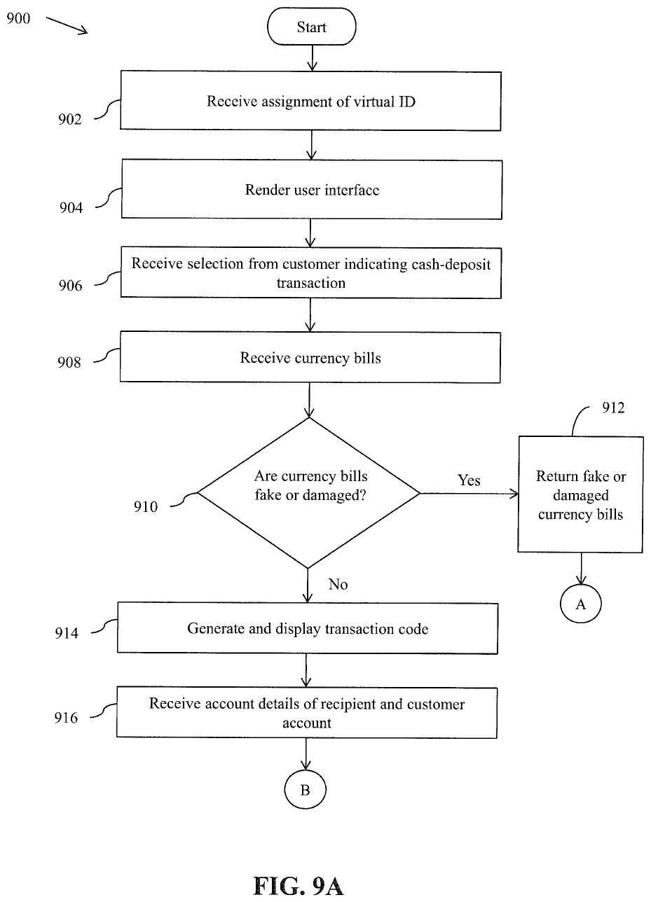

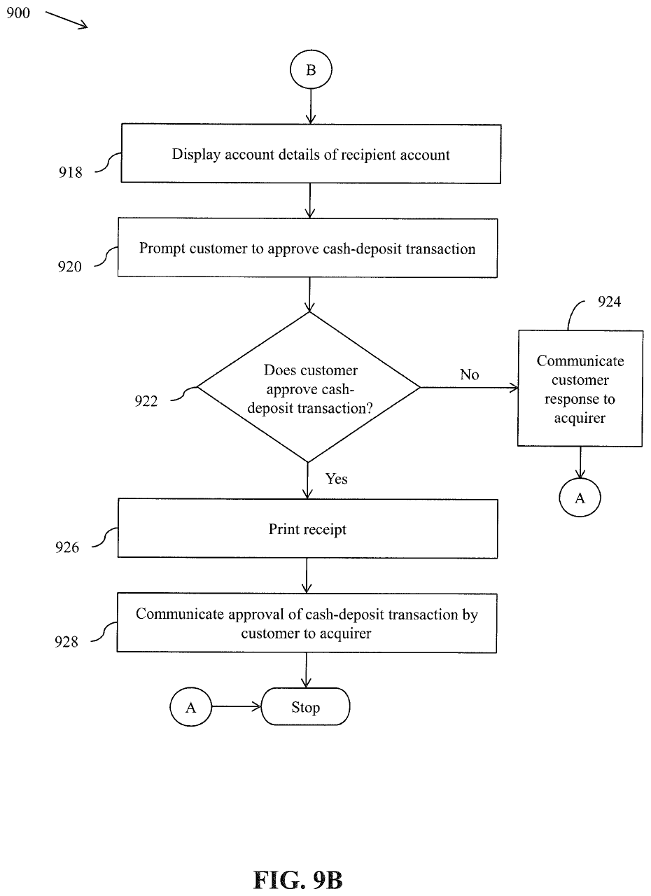

FIGS. 9A and 9B, collectively represent a flow chart 900 that illustrates the method for facilitating cash-deposit transactions, in accordance with another embodiment of the present invention. At step 902, the currency recycler 106 is assigned the first through third virtual IDs by the first through third payment networks. At step 904, the currency recycler 106 renders the UI screen 402 (as described in the foregoing description of FIG. 4A). The first customer 102 approaches the currency recycler 106 and selects the second customer-selectable option 414 for performing the cash-deposit transaction. At step 906, the currency recycler 106 receives the selection of the second customer-selectable option 414. At step 908, the currency recycler 106 receives the currency bills submitted by the first customer 102. At step 910, the currency recycler 106 determines whether any currency bill is fake or damaged. At step 910, if it is determined that a currency bill is fake or damaged, step 912 is performed. At step 912, the currency recycler 106 returns the fake or damaged currency bill to the first customer 102. At step 910, if it is determined that no currency bill is fake or damaged, step 914 is performed. At step 914, the currency recycler 106 generates and displays the transaction code 418 (i.e., the first QR code). The first customer 102 captures the transaction code 418 using the service application 118. The first issuer server 112 receives the captured transaction code 418 and the account details of the recipient account from the service application 118. The first issuer server 112 generates the approval request and communicates the approval request to the acquirer server 108 by way of the payment network server 110.

At step 916, the currency recycler 106 receives the account details of the recipient account from the acquirer server 108 and is further instructed, by the acquirer server 108, to display the account details of the recipient account to the first customer 102 for approval. At step 918, the currency recycler 106 displays the account details of the recipient account. At step 920, the currency recycler 106 prompts the first customer 102 to approve the cash-deposit transaction (as described in the foregoing in FIG. 4B). The first customer 102 approves or declines the cash-deposit transaction by selecting the fourth or fifth customer-selectable options 420a or 420b, as described in the foregoing description of FIG. 4B. At step 922, the currency recycler 106 determines whether the first customer 102 has approved the cash-deposit transaction. If at step 922, the currency recycler 106 determines that the first customer 102 has declined the cash-deposit transaction, step 924 is performed. At step 924, the currency recycler 106 communicates the selection of the fifth customer-selectable option 420b by the first customer 102 to the acquirer server 108. If at step 922, the currency recycler 106 determines that the first customer 102 has approved the cash-deposit transaction, step 926 is performed. At step 926, the currency recycler 106 prints the receipt of the cash-deposit transaction for the first customer 102 and displays a message indicating that the cash-deposit transaction is approved (as shown in FIG. 4B). At step 928, the currency recycler 106 communicates the selection of the fourth customer-selectable option 420a by the first customer 102 to the acquirer server 108.

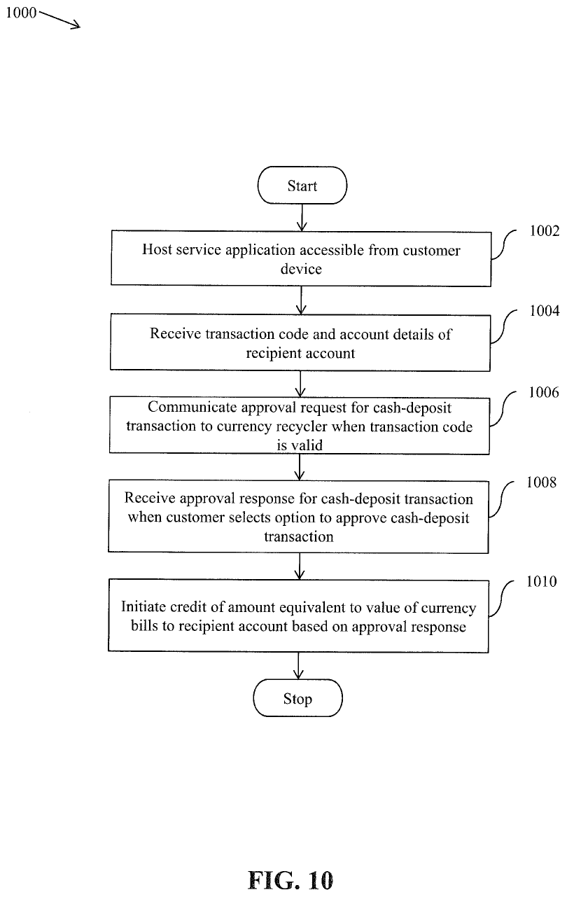

FIG. 10 represents a high-level flow chart 1000 that illustrates the method for facilitating cash-deposit transactions, in accordance with an embodiment of the present invention. At step 1002, the first issuer server 112 hosts the service application 118 that is accessible on the customer device 104. At step 1004, the first issuer server 112 receives the transaction code 418 (i.e., the first or second QR code) and the account details of the recipient account from the service application 118. The transaction code 418 is generated when the first customer 102 submits the currency bills to the currency recycler 106 for performing the cash-deposit transaction. The transaction code 418 is captured by the service application 118. At step 1006, the first issuer server 112 communicates the approval request when the transaction code 418 is valid. The currency recycler 106 presents the fourth customer-selectable option 420a to the first customer 102 based on the approval request. At step 1008, the first issuer server 112 receives the approval response when the first customer 102 selects the fourth customer-selectable option 420a to approve the cash-deposit transaction. At step 1010, the first issuer server 112 initiates a credit of amount equivalent to value of currency bills to the recipient account based on approval response.

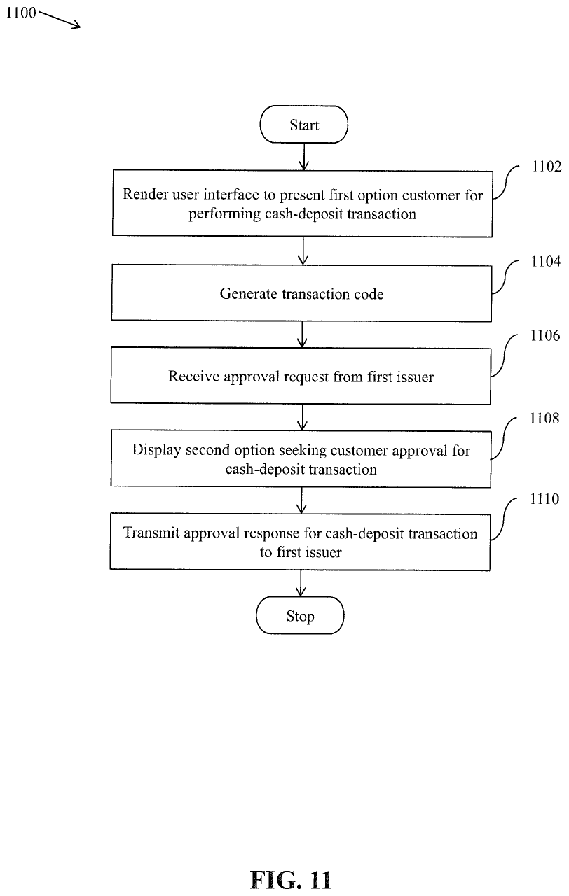

FIG. 11 represents a high-level flow chart 1100 that illustrates the method for facilitating cash-deposit transactions, in accordance with another embodiment of the present invention. At step 1102, the currency recycler 106 renders the UI screen 402 to present the second customer-selectable option 414 (i.e., the first option) to the first customer 102 for performing the cash-deposit transaction at the currency recycler 106. The first customer 102 selects the second customer-selectable option 414 to perform the cash-deposit transaction. At step 1104, the currency recycler 106 generates the transaction code 418 (i.e., the first or second QR code) that has encoded therein, the first through third virtual IDs of the currency recycler 106 and a first amount. The first amount is equivalent to the value the currency bills submitted by the first customer 102 to the currency recycler 106 for the cash-deposit transaction. The transaction code 418 is captured by the service application 118, which is accessible on the customer device 104. The service application 118 communicates the transaction code 418 and the account details of the recipient account to the first issuer server 112. At step 1106, the currency recycler 106 receives the approval request from the first issuer server 112 when the transaction code 418 is determined to be valid by the first issuer server 112. At step 1108, the currency recycler 106 displays the fourth customer-selectable option 420a (i.e., the second option) to seek approval of the first customer 102 for the cash-deposit transaction. At step 1110, the currency recycler 106 transmits the approval response to the first issuer server 112 based on the selection of the fourth customer-selectable option 420a (i.e., the second option). The approval response causes the first issuer server 112 to credit the first amount to the recipient account.

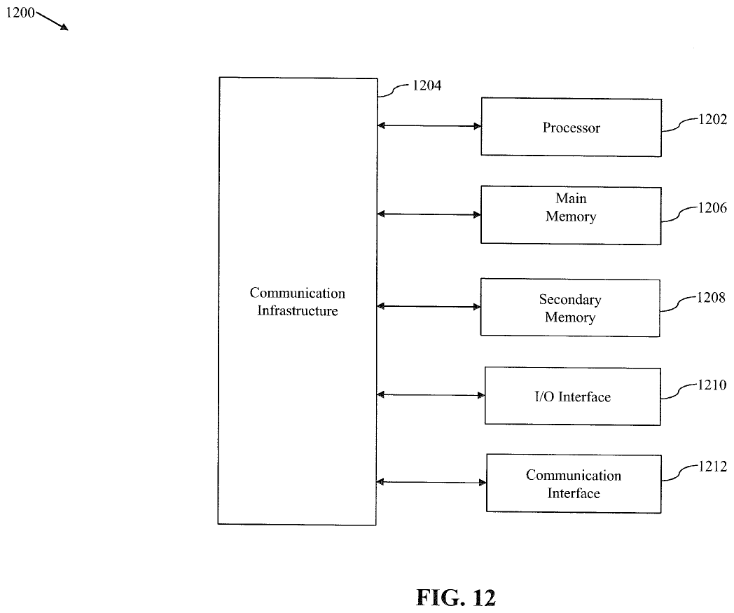

FIG. 12 is a block diagram that illustrates system architecture of a computer system 1200, in accordance with an embodiment of the present invention. An embodiment of present invention, or portions thereof, may be implemented as computer readable code on the computer system 1200. In one example, the customer device 104, the currency recycler 106, the acquirer server 108, the payment network server 110, the first issuer server 112, and the second issuer server 114 of FIG. 1 may be implemented in the computer system 1200 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 8A-8C, 9A, 9B, 10 and 11.

The computer system 1200 includes a processor 1202 that may be a special-purpose or a general-purpose processing device. The processor 1202 may be a single processor, multiple processors, or combinations thereof. The processor 1202 may have one or more processor cores. In one example, the processor 1202 is an octa-core processor. The processor 1202 may be connected to a communication infrastructure 1204, such as a bus, message queue, multi-core message-passing scheme, and the like. The computer system 1200 may further include a main memory 1206 and a secondary memory 1208. Examples of the main memory 1206 may include RAM, ROM, and the like. The secondary memory 1208 may include a hard disk drive or a removable storage drive, such as a floppy disk drive, a magnetic tape drive, a compact disc, an optical disk drive, a flash memory, and the like. The removable storage drive may read from and/or write to a removable storage device in a manner known in the art. In one example, if the removable storage drive is a compact disc drive, the removable storage device may be a compact disc. In an embodiment, the removable storage unit may be a non-transitory computer readable recording media.

The computer system 1200 further includes an input/output (I/O) interface 1210 and a communication interface 1212. The I/O interface 1210 includes various input and output devices that are configured to communicate with the processor 1202. Examples of the input devices may include a keyboard, a mouse, a joystick, a touchscreen, a microphone, and the like. Examples of the output devices may include a display screen, a speaker, headphones, and the like. The communication interface 1212 may be configured to allow data to be transferred between the computer system 1200 and various devices that are communicatively coupled to the computer system 1200. Examples of the communication interface 1212 may include a modem, a network interface, i.e., an Ethernet card, a communication port, and the like. Data transferred via the communication interface 1212 may correspond to signals, such as electronic, electromagnetic, optical, or other signals as will be apparent to a person skilled in the art. The signals may travel via a communication channel (not shown) which may be configured to transmit the signals to devices that are communicatively coupled to the computer system 1200. Examples of the communication channel may include, but are not limited to, cable, fiber optics, a phone line, a cellular phone link, a radio frequency link, and the like.

Computer program medium and computer usable medium may refer to memories, such as the main memory 1206 and the secondary memory 1208, which may be a semiconductor memory such as a DRAM. These computer program mediums may provide data that enables the computer system 1200 to implement the methods illustrated in FIGS. 8A-8C, 9A, 9B, 10, and 11. In an embodiment, the present invention is implemented using a computer implemented application, the computer implemented application may be stored in a computer program product and loaded into the computer system 1200 using the removable storage drive or the hard disc drive in the secondary memory 1208, the I/O interface 1210, or the communication interface 1212.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into digitally any device. For instance, at least one processor such as the processor 1202 and a memory such as the main memory 1206 and the secondary memory 1208 implements the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Thus, the environment 100 enhances convenience of performing cash-deposit transactions by allowing customers (such as the first customer 102) to perform cash-deposit transactions without transaction cards. The present invention also allows the first customer 102 to deposit money in bank accounts as well as digital wallets by way of the currency recycler 106, such that the bank account as well as the digital wallets may or may not be maintained at an acquirer operating the currency recycler 106. The present invention further supports cross-currency cash-deposit transactions, i.e., enabling the first customer 102 to perform cash-deposit transactions without restrictions in regards to currency of currency bills or location of currency recyclers. For example, the first customer 102 may perform a cross-currency cash-deposit transaction at an airport to deposit currency bills of a first currency to a bank account or a digital wallet having a second currency associated to it. Thus, the present invention offers a fast, convenient, and secure method to load digital wallets and bank accounts. The digital wallets may be of various types, such as debit, prepaid, or credit digital wallets. Since cash-deposit transactions are initiated by the first issuer server 112, and not by the acquirer server 108, the present invention offers a high level of security for the cash-deposit transactions, as source(s) of the cash-deposit transactions can be easily traced. Consequently, the cash-deposit transactions are less prone to dispute.

The present invention also offers prospects of increased business to issuers, such as the first issuer. Through inclusion of ‘off us’ cash-deposit transactions, the first issuer may charge the first customer 102 a nominal fee for facilitating cash-deposit transactions performed by the first customer 102 at currency recyclers (such as the currency recycler 106) of another financial institution (such as the first acquirer). The first issuer may charge the first customer 102 a suitable processing fees whenever the first customer 102 performs a cross-currency cash-deposit transaction. The present invention may be implemented using existing payment network APIs, therefore implementation of the present invention does not require any change in payment network APIs that are currently used. Additionally, no changes are required in clearing and dispute processing with respect to cash-deposit transactions. Methods for clearing and dispute processing will remain same as those currently used for issuer initiated payment transactions. Since the present invention is compatible with major payment networks and offers support for depositing money in digital wallets, the present invention offers a high degree of scalability.

Techniques consistent with the present invention provide, among other features, systems and methods for processing cash-deposit transactions. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for facilitating cash-deposit transactions, the method comprising:
hosting, by an issuer server of a first issuer, a service application that is accessible to a first customer on a customer device;
receiving, by the issuer server from the service application, a transaction code and account details of a recipient account, wherein the transaction code is generated by a currency recycler when the first customer submits one or more currency bills to the currency recycler for performing a cash-deposit transaction, and wherein the transaction code is captured by the service application;
communicating, by the issuer server to the currency recycler, an approval request for the cash-deposit transaction when the transaction code is valid, wherein the currency recycler presents an option to the first customer to approve the cash-deposit transaction based on the approval request;
receiving, by the issuer server from the currency recycler, an approval response for the cash-deposit transaction when the first customer selects the option to approve the cash-deposit transaction; and
initiating, by the issuer server, a credit of an amount equivalent to a value of the one or more currency bills to the recipient account based on the approval response.

2. The method of claim 1, wherein the recipient account is maintained at the first issuer.

3. The method of claim 1, wherein the recipient account is maintained at a second issuer that is different from the first issuer.

4. The method of claim 1, wherein the transaction code has encoded therein, a first identifier assigned to the currency recycler and the amount equivalent to the value of the one or more currency bills.

5. The method of claim 1, further comprising validating, by the issuer server, the transaction code and the account details of the recipient account prior to communicating the approval request.

6. The method of claim 1, wherein the approval request includes the account details of the recipient account, and wherein the account details include a second identifier corresponding to the recipient account.

7. The method of claim 1, wherein a currency type of the one or more currency bills is different from a currency type of the recipient account.

8. A system for facilitating cash-deposit transaction, the system comprising:
an issuer server configured to:
host a service application accessible to a first customer on a customer device;
receive, from the service application, a transaction code and account details of a recipient account, wherein the transaction code is generated by a currency recycler when the first customer submits one or more currency bills to the currency recycler for performing a cash-deposit transaction, and wherein the transaction code is captured by the service application;
communicate, to the currency recycler, an approval request for the cash-deposit transaction when the transaction code is valid, wherein the currency recycler presents an option to the first customer to approve the cash-deposit transaction based on the approval request;
receive, from the currency recycler, an approval response for the cash-deposit transaction when the first customer selects the option to approve the cash-deposit transaction; and
initiate a credit of an amount equivalent to a value of the one or more currency bills to the recipient account based on the approval response.

9. The system of claim 8, wherein the transaction code has encoded therein, a first identifier assigned to the currency recycler and the amount equivalent to the value of the one or more currency bills.

10. The system of claim 8 or claim 9, wherein the issuer server is further configured to validate the transaction code and the account details of the recipient account prior to communicating the approval request.

11. The system of claim 8, wherein the approval request includes the account details of the recipient account, and wherein the account details include a second identifier corresponding to the recipient account.

12. The system of claim 8, wherein a currency type of the one or more currency bills is different from a currency type of the recipient account.

13. The system of claim 8, wherein the recipient account is maintained at a first issuer operating the issuer server.

14. The system of claim 8, wherein the recipient account is maintained at a first issuer that is different from a second issuer operating the issuer server.

15. A method for facilitating cash-deposit transactions, the method comprising:
rendering, by a currency recycler, a user interface to present a first option to a customer for performing a cash-deposit transaction at the currency recycler, wherein the customer selects the first option to perform the cash-deposit transaction;
generating, by the currency recycler, a transaction code that has encoded therein, a first identifier assigned to the currency recycler and a first amount equivalent to a value of one or more currency bills submitted by the customer to the currency recycler for the cash-deposit transaction, wherein a service application accessible on a customer device of the customer captures the transaction code, and communicates the transaction code and account details of a recipient account to a first issuer hosting the service application;
receiving, by the currency recycler from the first issuer, an approval request when the transaction code is determined to be valid by the first issuer;
displaying, by the currency recycler, a second option on the user interface to seek an approval from the customer for the cash-deposit transaction, based on the approval request; and
transmitting, by the currency recycler, an approval response for the cash-deposit transaction to the first issuer based on a selection of the second option by the customer, wherein the approval response causes the first issuer to initiate a credit of the first amount to the recipient account.

16. The method of claim 15, wherein the recipient account is maintained at the first issuer.

17. The method of claim 15, wherein the recipient account is maintained at a second issuer that is different from the first issuer.

18. The method of claim 15, wherein the currency recycler returns the one or more currency bills to the customer when the customer declines the cash-deposit transaction.

19. The method of claim 15, wherein the approval request includes the account details of the recipient account, and wherein the account details include a second identifier corresponding to the recipient account.

20. The method of claim 19, further comprising displaying, by the currency recycler, the account number of the account and the name of an account holder on the user interface, based on the approval request.
